(19) United States
(12) Patent Application Publication
(10) Pub. No.: US 2013/0277291 A1
(43) Pub. Date: Oct. 24, 2013

(54) INTEGRATED WATER PROCESSING TECHNOLOGY

(71) Applicant: Martin Hauschild, Ottawa (CA)

(72) Inventor: Martin Hauschild, Ottawa (CA)

(21) Appl. No.: 13/748,160

(22) Filed: Jan. 23, 2013

Related U.S. Application Data
(63) Continuation of application No. 12/738,172, filed on Jul. 19, 2010, now abandoned.
(60) Provisional application No. 61/016,547, filed on Dec. 24, 2007.
(60) Provisional application No. 60/979,996, filed on Oct. 15, 2007.

(51) Int. Cl. C02F 3/30

(52) U.S. Cl. CPC C02F 3/302
USPC 210/151

(57) ABSTRACT

The invention provides a Bioreactor-Membrane Integrated Technology (B-MIT), comprising an immobilized cellular system bioreactor that initially treats raw water, functionally integrated with a membrane system where the biologically treated water is filtered to generate high quality finished water.

### THE FIELD OF THE INVENTION

The present invention pertains to the field of water processing, specifically those water processing technologies that combine bioreactors with membrane technologies.

### BACKGROUND

Regulations relating to pollutant discharges from municipal wastewater treatment systems and other wastewater sources is becoming progressively more stringent. Pollutants in the waste water include conventional pollutants including Biochemical Oxygen Demand (BOD), Total Suspended Solids (TSS) as well as Chemical Oxygen Demand (COD), ammonia, total nitrogen, nitrate, nitrite and phosphorous. In addition, other pollutants may be present in the wastewater including toxic substances (for example organic or inorganic contaminants, heavy metals, xenobiotics, etc.) or biologically active substances (for example hormones, human and veterinary pharmaceutical products (including endocrine disrupting chemicals (EDCs) and antibiotics), “emerging contaminants” and “effluent organic matter” (EfOM).

Biological treatment systems such as membrane bioreactors have been used in water and wastewater treatment to provide high levels of finished water treatment. These activated-sludge-type processes typically involve a single basin at ambient pressure containing a series of coarse bubble aeration devices into which single or multiple modules (or groupings) of hollow fiber or plate-type UF or MF membranes are inserted. Waste enters one end of the basin, is mixed with a biomass containing active aerobic organisms, and air is added to provide oxygen. The mixture of biomass and water is referred to as “mixed liquor.” The solids in the mixed liquor are referred to as “mixed liquor suspended solids” (MLSS). During aeration, the membrane devices filter the particles of biomass from the liquid substrate. There are various suppliers of MBRs including Kubota, Memcor, Mitsubishi and GE-Zenon.

Typically, a major portion of the costs of operating these systems is the cost of providing air for the biological process through aeration, air for the membranes for air scour and/or backwash, and/or water for backwash. There exists a need for a system with reduced energy requirements.

### THE SUMMARY OF THE INVENTION

This invention provides a Bioreactor-Membrane Integrated Technology (B-MIT), comprising an immobilized cellular system bioreactor that initially treats raw water, functionally integrated with a membrane system where the biologically treated water is filtered to generate high quality finished water. Since the membrane system hydraulically drives the capacity of the B-MIT, the design of the bioreactor system optimizes the quality and flux of the water relative to the membrane system at the point of entry into the membrane system. The overall design of the B-MIT is generated relative to the needs of the application. Movement of water through the bioreactor can be active, i.e. by use of pumps and/or vacuums and/or passive, i.e. gravity feed. Optionally, the technology can comprise one or more pre-biological treatment processes, one or more post-biological treatment processes, one or more post membrane treatment processes, storage and/or distribution processes. The system optionally comprises a control system to monitor and manage the process.

### BRIEF DESCRIPTION OF FIGURES

Embodiments of the invention will now be described, by way of example only, by reference to the attached Figures.

FIG. 1 is a schematic of a water treatment facility comprising one embodiment of the B-MIT (10) comprising a bioreactor (100) having one immobilized cellular system (150) and a membrane system (500).

FIG. 2 is a schematic of a water treatment facility comprising one embodiment of the B-MIT (10) comprising a bioreactor having two immobilized cellular systems (150) and one membrane system (500).

FIG. 3 is a schematic of one embodiment of the B-MIT comprising bioreactor having one cellular system and one membrane system, detailing the components of one embodiment of the B-MIT.

FIG. 4 is a schematic of one embodiment of the B-MIT comprising one cellular system and one membrane system, detailing the components of one embodiment of the B-MIT.

FIG. 5 is a schematic of one embodiment of the B-MIT detailing the flow of raw water and material through the system.

FIG. 6 is a schematic of one embodiment of the B-MIT comprising a modular cellular system.

FIG. 7 is a schematic of one embodiment of the B-MIT comprising a modular cellular system and detailing the flow of raw water and material through the system.

FIG. 8 is a schematic detailing one Rotordisk® embodiment of the Rotating Biological Contractor showing the rotorzone disk banks (801), inlet pipe (802), drive (803), final clarifier (804), effluent V-notch weir (805), outlet pipe (806), optional pump chamber (807), biosolids storage (808), primary clarifier (809), rotorzone (810), submerged inlet to rotorzone (811) and optional handrail and grating (812).

FIG. 9 is a schematic detailing the components of one embodiment of the membrane system.

FIG. 10A is a system layout schematic of one embodiment of the B-MIT plant having multiple treatment strings each having a four stage Rotating Biological Contactor and membrane system. FIG. 10B is a detailed schematic of one string in the treatment plant of FIG. 10A showing the first RBC stage (1001), second RBC stage (1002), third RBC stage (1003) and fourth RBC stage (1004) and the membrane unit (1005). FIG. 10C is a schematic detailing fluid flow through the treatment string shown in FIG. 10B.

FIG. 11 shows alternate views of various components of the system of FIG. 10.

FIG. 12 shows alternate views of the system of FIG. 10.

FIG. 13 is a schematic of one embodiment of the B-MIT comprising bioreactor having multiple immobilized cell systems and a membrane system and in which the holding tank for the bioreactor and the membrane system is common.

FIGS. 14A and B are listings of equipment for an exemplary facility.

### THE DETAILED DESCRIPTION OF THE INVENTION

### Definitions

Unless defined otherwise, all technical and scientific terms used herein have the same meaning as commonly understood by one of ordinary skill in the art to which this invention belongs.

As used herein, the term “about” refers to a +/−10% variation from the nominal value. It is to be understood that such a variation is always included in any given value provided herein, whether or not it is specifically referred to.

As used herein, the term “bioreactor” refers to a biological treatment system comprising one or more cellular systems.

As used herein, the term, “biological treatment/processing zone” refers to a zone or area within the bioreactor in which specific biological processes are occurring or are predominant.

As used herein, the term “cellular system” refers to a system comprising one or more biological treatment units housed within a holding tank. Examples include any fixed growth cellular systems in which cells are immobilized to a surface including but not limited to fixed-cell, fixed-film, fixed bed, fluidized beds, air-sparged, trickling filters, rotating media reactors and rotating biological contractor.

As use herein, the term “biological treatment unit” includes a biological component and a biological support component.

As used herein, the term, “raw water,” refers to any untreated water, wastewater and/or intake water including any water, the quality of which is desired to be improved. This can include water from naturally occurring sources that is of poor quality, non-potable and/or contaminated, contaminated water from man-made activities including industrial, agricultural, commercial, rural and/or domestic activities and/or natural disasters, land-based water, sea and/or ocean based water.

As used herein, the term, “wastewater,” includes residential, commercial, industrial, leachate or agricultural liquid wastes, septage, storm water runoff, or any combination thereof or other liquid residue discharged or collected.

As used herein, the term, “biologically processed water,” refers to the water that has completed its passage and treatment through the bioreactor.

As used herein, the term, “treated biologically processed water,” refers to biologically processed water that has passed through an additional treatment prior to entering the membrane system.

As used herein, the term, “effluent,” refers to water that has been processed by the B-MIT.

As used herein, the term, “treated effluent,” refers to water that has been processed by the B-MIT and has received one or more additional treatments.

### Overview of the Bioreactor-Membrane Integrated Technology (B-MIT)

This invention provides a Bioreactor-Membrane Integrated Technology (B-MIT), comprising an immobilized cellular system bioreactor that initially treats raw water, functionally integrated with a membrane system where the biologically treated water is filtered to generate high quality finished water. Since the membrane system hydraulically drives the capacity of the B-MIT, the design of the bioreactor system optimizes the quality and flux of the water relative to the membrane system at the point of entry into the membrane system.

In order to optimize the overall efficiency and effectiveness of the B-MIT, a balance is struck between too slow of a flow or low flux (which reduces the efficiency of the system) and too great a flow or high flux (which exceeds the capacity of the membrane system). The system is designed such that even if there is zero flow of water through the membrane system, the membrane system will not dry out. The limiting factor is that the flow of water into the membrane system can not exceed the flow capacity and minimal quality requirements of the membrane system.

There is provided a Bioreactor-Membrane Integrated Technology (B-MIT), comprising an immobilized cellular system bioreactor integrated with a membrane system to treat raw water, the quality of which is in need of improvement. Raw water enters the bioreactor and is processed biologically by one or more cellular systems prior to entering the membrane system where it is filtered. The two systems are integrated such that the processes that occur in the biological stage are linked to the design and/or performance of the membrane stage.

The integration of the bioreactor with the membrane system allows for the integration of the biological and physical processes resulting in a functional and efficient system. In particular, since the feed to the membrane system (i.e. the biologically processed water) would have lower concentrations of contaminants, a higher, more constant permeate (filtrate) flux can be achieved. Optionally, such an integrated system could reduce irreversible and reversible fouling, reduce scaling, lower power requirements, allow for lower or less frequent aeration and/or provide a straightforward process for cleaning the membranes. Compared to conventional wastewater treatment systems, the B-MIT provides a more compact facility, more concentrated biomass, a reduced sludge yield and lower power consumption.

As an integrated technology, the invention comprises one or more biological treatment/processing zones housed within the bioreactor, which successively remove contaminants from the raw water thereby obtaining an output of biologically processed water having characteristics that are suitable for further treatment and/or filtering by the membrane system. Optionally, the bioreactor may comprise various sensors to monitor the quality of the biologically processed water and/or monitor biological processing directly or indirectly. Effectors in the bioreactor receiving information from theses sensor may be responsive to these signals and increase residence time and/or add process additives or conditioners if water quality does not meet a minimum threshold or divert poor quality water for additional pre-membrane treatment. The membrane system filters the biologically treated water to obtain an effluent for use in a variety of downstream applications.

The B-MIT process to treat raw water is applicable to the treatment of any raw water that is amenable to biological treatment or digestion. The B-MIT process is readily adaptable such that varied degrees of contaminants removal can be accomplished. The process may be tailored to the degree and consistency of treatment required, type of waste to be treated, site constraints, and capital and operating costs. Factors to consider in designing a B-MIT include organic and hydraulic loading rates; influent raw water characteristics; effluent requirements; raw water temperature; biofilm control; dissolved oxygen (DO) levels; and flexibility in operation.

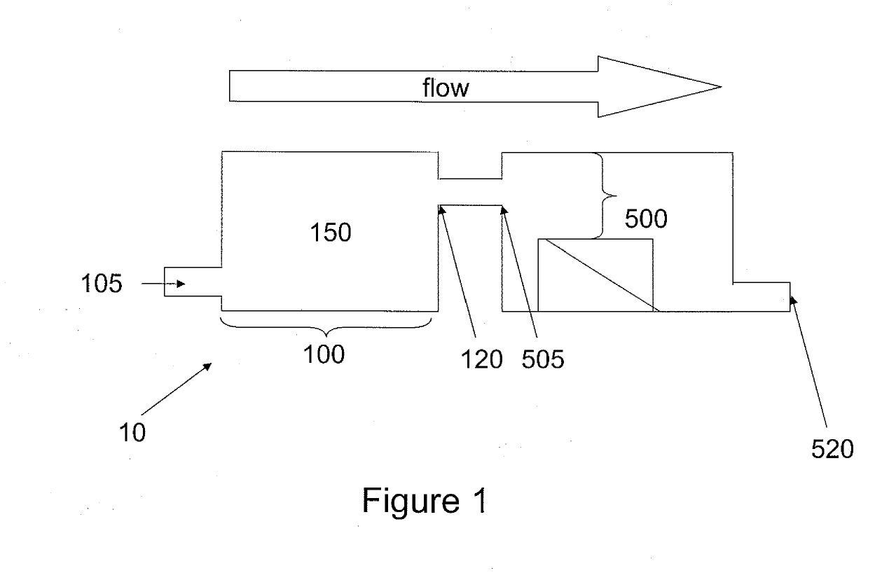

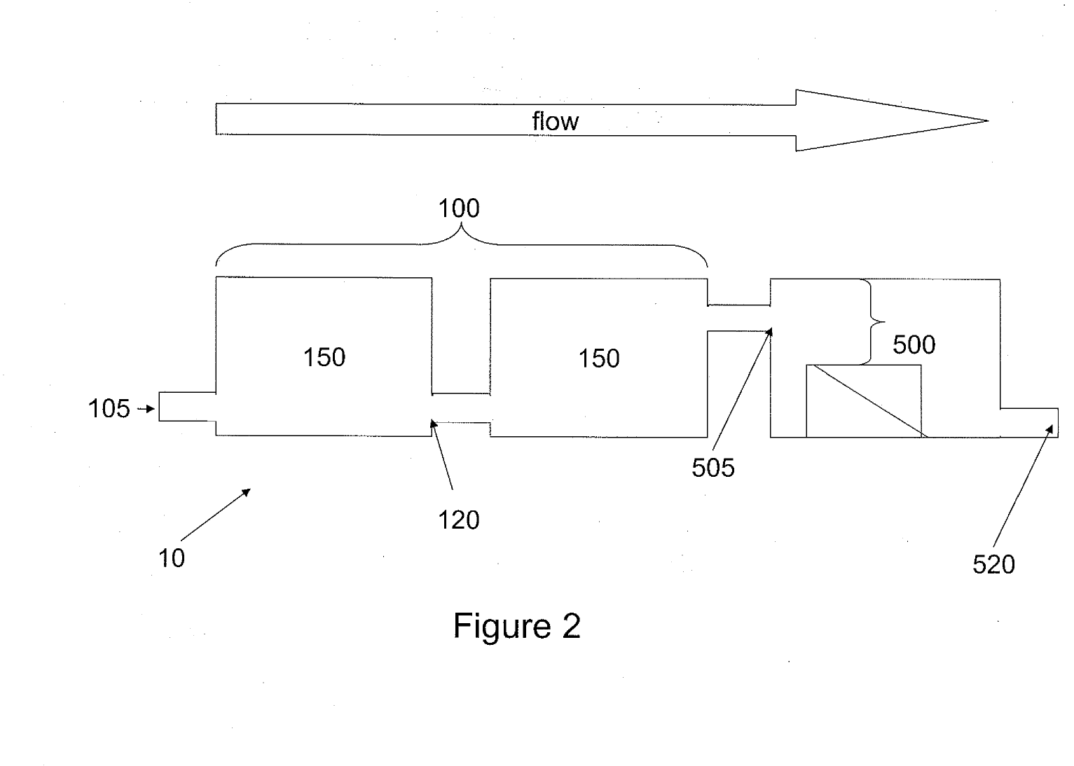

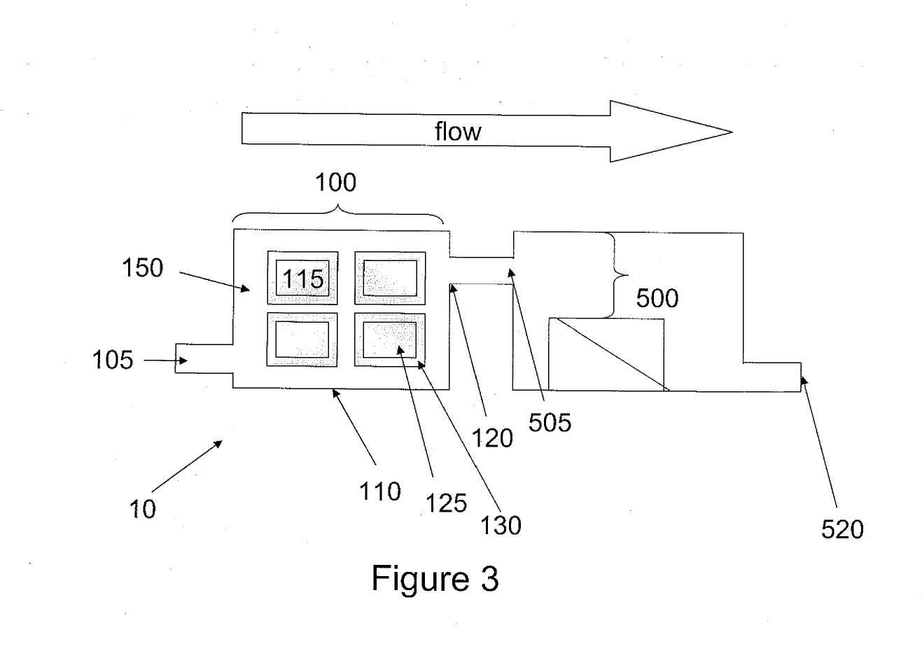

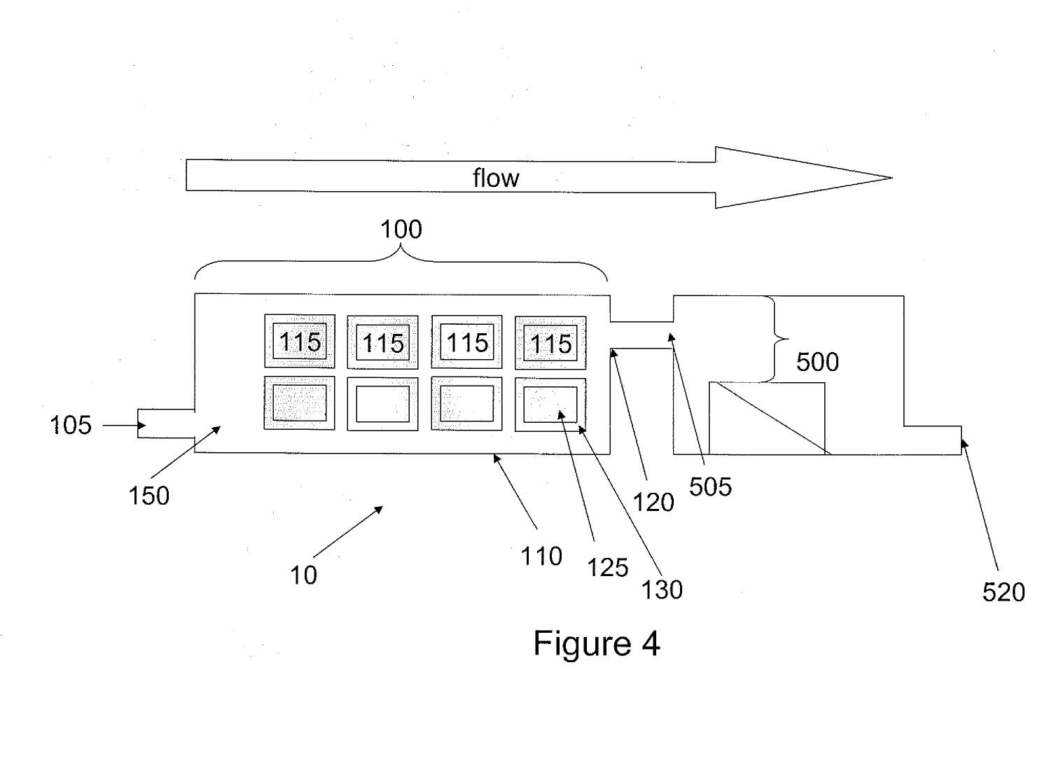

Referring to FIGS. 1 through 5, there is provided a Bioreactor-Membrane Integrated Technology (B-MIT) (10). This technology comprises a bioreactor (100) having one or more immobilized cellular systems (150) integrated with one or more membrane systems (500). Raw water enters the one or more cellular systems (150) of the bioreactor (100) via one or more raw water inputs (105) and is progressively treated and optionally conditioned prior to entering the membrane system (500) for filtering via inlet (505). Filtered effluent exits the system via outlet (520). Optionally, the B-MIT (10) can comprise one or more pre-biological treatment modules and/or one or more post membrane treatment, storage and/or distribution modules.

Appropriate post membrane treatment are known in the art and include disinfection with UV, chlorine, hydrogen peroxide, photolysis, ozone and bromine among others. The dependency on post membrane disinfection may be reduced by carefully selecting membranes with pore openings of a size that trap a significant proportion of pathogenic organisms. In one embodiment, the size range of the pores is between about 0.08-about 0.4 μm.

The biologically processed water may be fed directly into the membrane system or may be subjected to further processing or treatment prior to entering the membrane system. Optional further processing includes clarifying, coarse filtering with a sand or metal mesh filter or the like, conditioning using various polymers, biopolymer removal or combinations thereof. Optionally, conditioning and/or biopolymer removal may be concurrent with biological treatment.

For effective integration of the bioreactor and the membrane system, the water entering the membrane system has a Total Suspended Solids (TSS) concentration equal to or less than 100 mg/l; and a Biochemical Oxygen Demand −5 days (BOD₅) concentration equal to or less than 100 mg/l. Optionally, other measures of organic carbon in the wastewater can be used in place of or in addition to BOD₅. Other direct or indirect measurements methods such as Total Organic Carbon (TOC), Chemical Oxygen Demand (COD), Volatile Suspended Solids (VSS), etc. can be used to track the concentration of organic carbon in the water arising from the biological treatment. A worker skilled in the art would appreciate, in view of the BOD₅ level disclosed above, what level of organic carbon as measured directly or indirectly by various other means is low enough to be suitable for the membrane system to be effective.

In some embodiments, for optimum results, the colloid solids or particles within the water entering the membrane system should predominantly be neutral or negatively charged. A worker skilled in the art would appreciate which membrane designs function more efficiently under these conditions. Accordingly in such embodiments to ensure that the membrane process is fed with water having neutral or negatively charged colloidal solids or particles, a membrane-compatible polymer is added to the biologically processed water prior to filtration. Appropriate polymers are known in the art and include Nalclear® 7767, Nalclear® 7768 and the anionic polyelectrolyte 1C34.

In one embodiment, the quality of the biologically processed water maximizes the life of the membranes within the membrane system. For example, in one embodiment, the pH of the biologically processed water is adjusted such that it is low enough to discourage the formation of calcium carbonate or other salts scaling on the membranes while being suitable for bacterial growth, including the growth of nitrifiers.

Referring now to FIGS. 1 through 5, generally, the B-MIT (10) comprises a bioreactor (100) having at least one holding tank (110) with raw water input (105) for receiving water from a primary settling tank or other source, biologically processed water output (120) in fluid communication with a membrane system (500) having filtered water product (effluent) output (520). The holding tank (110) is equipped with at least one biological processing/treatment unit (115). The B-MIT (10) can optionally further comprise a monitoring and/or control system and further upstream or downstream processing, holding and/or distributions units.

During processing, raw water that has optionally been pre-clarified by settling and/or screening to remove large solids is introduced into the bioreactor (100) at one end; hereafter referred to as the upstream end, through the raw water input (105) and flows from the upstream end towards the downstream or output end (120) of the bioreactor. Optionally, a non-toxic and non-inhibitory membrane-compatible polymer is added to condition the water to ensure that the membrane process is fed with water containing neutral or negatively charged colloidal solids or particles. As the raw water progresses through the bioreactor, water quality progressively improves as contaminants are digested by the microbial community. Biologically processed water of a minimum quality is fed from the bioreactor into the membrane system. Optionally, biologically processed water below the minimum quality threshold is re-circulated into the bioreactor for further processing or diverted for a series of pre-membrane clarifying and/or filtration steps.

### The Bioreactor

The bioreactor comprises one or more cellular systems defining one or more biological treatment/processing zones for the successive processing of raw water to remove various contaminants. During processing within the bioreactor, organic matter is transformed into CO₂ and inorganic soluble or insoluble matter. Other contaminants that are removed by biological processes include TAN (Total Ammonia Nitrogen) and total suspended solids (TSS). Total Phosphorus (TP) is also removed by biological processes and can optionally be further removed by chemical and physical means (precipitation and physical retention of precipitates) downstream the biological process in a tertiary treatment system such as the membrane system.

In one embodiment, the bioreactor comprises two or more biological treatment/processing zones. In one embodiment, the bioreactor comprises three or more biological treatment/processing zones. The number of biological treatment/processing zones is, in part, determined by the treatment/processing capacity requirements of the membrane system component of the B-MIT.

Accordingly, the bioreactor comprises one or more fixed-cellular systems housed within a holding tank that has a raw water input and biologically processed water output. As raw water progress through the bioreactor, microbes progressively digest organic components within the raw water and remove contaminants. The bioreactor may optionally further comprise various processes to facilitate biofilm/microbe growth or improve the digestion/processing of the raw water or improve the quality of the processed water.

In bioreactors comprising two cellular systems, both cellular systems may be identical or distinct. In bioreactors comprising three or more cellular systems, all systems may be identical or distinct or two or more cellular systems may be identical.

In one embodiment, individual cellular systems are tailored to specific characteristics of the raw water at specific locations within the bioreactor. In such embodiments, the bioreactor may comprise serially changing population of microorganisms that are adapted to process improving quality of raw water or changing raw water characteristics.

In one embodiment, the cellular systems are tailored to the general/average characteristics of the raw water within the bioreactor.

### Bioreactor Design Considerations

A worker skilled in the art would appreciate that several factors may be considered when designing an appropriate bioreactor to meet system requirements and provide biologically processed water of a minimum quality to the membrane system.

In particular, the bioreactor is designed to i) input the raw water to be processed, ii) support biofilm or fixed-cell growth, and iii) output processed water of a minimum quality acceptable to the membrane system.

In one embodiment, the bioreactor is designed such that the output processed water has a Total Suspended Solids (TSS) concentration equal to or less than 100 mg/l; and a Biochemical Oxygen Demand −5 days (BOD₅) concentration equal to or less than 100 mg/l. In one embodiment, the bioreactor is designed such that the output processed water has a Total Suspended Solids (TSS) concentration equal to or less than 75 mg/l; and a Biochemical Oxygen Demand −5 days (BOD₅) concentration equal to or less than 75 mg/l. In one embodiment, the bioreactor is designed such that the output processed water has a Total Suspended Solids (TSS) concentration equal to or less than 50 mg/l; and a Biochemical Oxygen Demand −5 days (BOD₅) concentration equal to or less than 50 mg/l.

A primary design consideration is organic loading or weight per unit time per volume. In determining design loading rates for the bioreactor, a number of parameters can be considered including design flow rates and primary raw water constituents or composition; total organic content of raw water; soluble organic content of raw water; percentage of total and soluble organic content of raw water to be removed; raw water temperature; primary effluent dissolved oxygen; surface area available for attachment of microbes; flow dynamics of water within the system; retention time within the cellular system; influent hydrogen sulfide concentrations; peaking loading; maximum organic loading; average organic loading; total Kjeldahl nitrogen; diurnal load variations, pH and alkalinity. Other important design considerations include the type and concentration of contaminants, total dissolved solids and potential for scaling in the wastewater. Accordingly, pre-design testing of raw water facilitates the application of a specific design of the bioreactor. One skilled in the art would further appreciate that the design of the bioreactor is impacted by the design and functional requirements of the membrane system.

The bioreactor comprises one or more cellular systems and one or more holding tanks.

### Cellular Systems

Generally, individual fixed-growth cellular systems comprise one or more biological treatment units. Each treatment unit (115) has a biological component (130) and a biological component support (125). Additional optional components of the cellular system include motors, pumps, heating elements, sensors, effectors, aeration elements, process additive inputs, etc.

Various types of fixed-growth cellular systems are known in the art and include fixed-cell, fixed-film, fixed bed, fluidized beds, air-sparged, trickling filters or rotating media reactors, rotating biological contactor and packed cage rotating biological contactor. A worker skilled in the art would appreciate which type of fixed-growth cellular system is appropriate for a specific application.

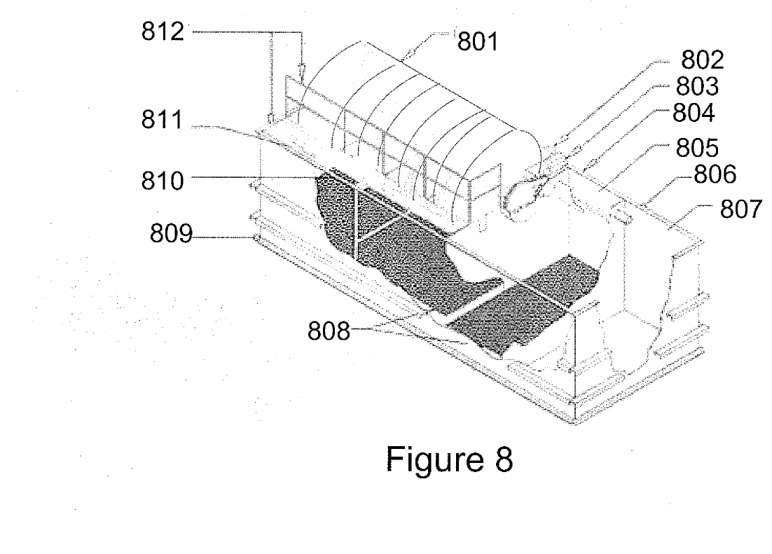

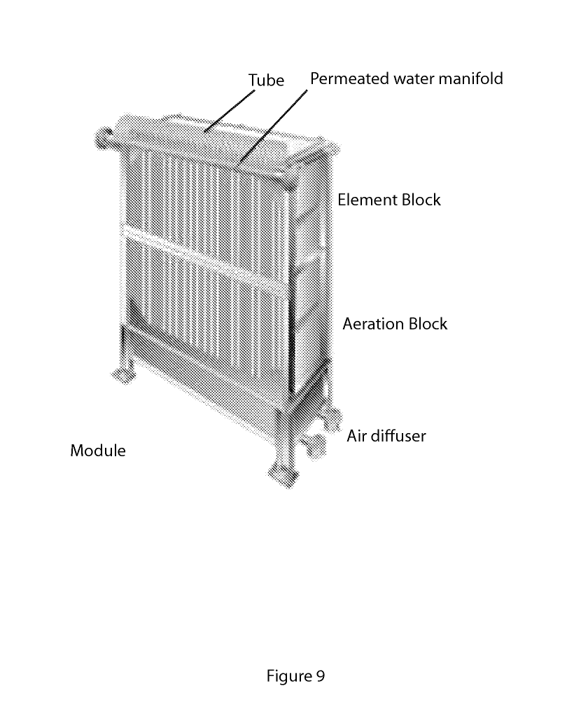

In one embodiment, the cellular system comprises a Rotordisk® rotating biological contactor (RBC) as illustrated in FIG. 8. In one embodiment, the bioreactor comprises more than one Rotordisk®.

In one embodiment, the RBC is a multistage RBC optionally designed to maximize removal of BOD and ammonia nitrogen. In one embodiment, the RBC is a three or four stage RBC. In one embodiment, a post-denitrification system follows the RBC to convert nitrate nitrogen into nitrogen gas.

In one embodiment of the multistage RBCs, all the stages are on a single shaft with interstage baffles installed between the stages. Optionally, the flow path of the water is parallel to the shaft. In one embodiment of the multistage RBCs, the individual stages are on individual shafts. Optionally, the flow path of the water is such that the water is introduced perpendicular to the shaft and is distributed evenly across the face of the RBCs.

### Biological Component

The biological component of a cellular system comprises a biofilm or plurality of fixed cells and is composed of one or more species of microbes. In one embodiment, the biofilm comprises a single type of microbe. In one embodiment, the biofilm comprises two or more types of microbes. In one embodiment, the biofilm comprises a plurality of microbe types.

A worker skilled in the art would appreciate that any type of microbe capable of fixed growth would be a candidate for use in the biological treatment/processing unit of the cellular system. Appropriate microbes include bacteria, micro-algae, yeasts, protozoa, fungi, nematodes, ciliates etc. or combinations thereof. In one embodiment, the biofilm is predominantly comprised of one or more species of yeast. The microbes include obligate aerobes, facultative aerobes, microaerophiles, aerotolerant organisms, obligate anaerobes and facultative aerobes. The biofilm may comprise filamentous or unicellular bacteria or combinations thereof. The type of microbes in the biofilm is dependent of the composition and characteristics of the raw water to be treated including but not limited to the concentration and type of contaminants, raw water pH and temperature.

Accordingly, the microbial biofilms may be enriched for carbonaceous bacteria, methanogenic bacteria, nitrifying bacteria, sulfide-oxidizing bacteria, denitrifying bacteria, phosphate accumulating bacteria, methylotrophic bacteria, xenobiotic degrading bacteria, anaerobic ammonium oxidizing (anammox) bacteria, and iron-oxidizing bacteria.

The biofilm may be stratified, with layers within the biofilms having unique ecosystem of organisms. The stratification of the biofilm may, in part, result from variations in dissolved oxygen (DO).

In one embodiment, the biofilm comprises a community or consortium of organisms or an ecosystem, which, optionally, functions as a collective or collaborate to remove contaminants from the raw water. Such a consortium may function to remove a particular contaminant from the raw water by a multistep process. For example a two step removal process would be as follows: microbe A would digest contaminant X into Product Y, microbe B would remove from the raw water or digest Product Y into a second acceptable product.

In one embodiment, the multistep removal process removes TAN. The TAN is removed by nitrification as the bacteria Nitrosomonas transform NH₄⁺ into NO₂⁻ (nitrite). The bacteria Nitrobacter transform NO₂⁻ into NO₃⁻ (nitrate)); Nitrate (NO₃⁻) is removed by denitrification, a biological process, which results in the transformation of NO₃⁻ into gaseous nitrogen (N₂).

Accordingly, in one embodiment, the microbial biofilms are seeded with specific microorganisms. Optionally, the microbial biofilms are tailored for specific conditions, including but not limited to presence of toxic substances (for example organic or inorganic contaminants, heavy metals, xenobiotics, etc.) or biologically active substances (for example hormones, human and veterinary pharmaceutical products (including endocrine disrupting chemicals (EDCs) and antibiotics) in the raw water, raw water composition, pH, temperature etc.

The microbial biofilms may be further tailored to remove “emerging contaminants” from the raw water including, but is not limited to: pesticides, fertilizers, herbicides, human and veterinary pharmaceutical products (including endocrine disrupting chemicals (EDCs) and antibiotics), cleaning products (including antibacterial agents), personal care products (PPCPs), surfactants, trihalomethanes (THM), perfluorinated compounds (PFCs), plasticizers, etc. Other contaminants which are of increasing concern are categorized as “effluent organic matter” (EfOM). EfOM include natural organic matter (NOM), soluble microbial products (SMPs) and trace harmful chemicals such as all “emerging contaminants” named earlier. As such, the biofilms may be specifically tailored to remove EfOM

In embodiments in which the biofilms are tailored for specific conditions and/or applications, the inputted raw water may be pre-treated to remove any resident microflora. Pre-treatment may include chemical treatment, decontamination (e.g., treatment with ozone), advanced oxidation (e.g., irradiation, ozone, hydrogen peroxide, photocatalysis), heating, etc. Such pre-treatment may be desirable when the raw water is contaminated with human or animal pathogens including but not limited to agricultural waste contaminated with E. coli O157:H7 from livestock fecal matter.

In one embodiment, the biological component comprises genetically engineered microorganisms specifically tailored for the application/process. For example, genetically engineered microorganisms may have enhanced degradation activities or increased spectrum of activities, and may be optimized to handle a specific contaminant. Alternatively, genetically engineered microorganisms may be specifically adapted for raw water pH, temperature and/or composition.

The biological component is immobilized within individual biological treatment/processing units by adhering or confining the microbial cells to the biological component support member. Appropriate immobilization techniques are known in the art and include non-specific absorption; specific attachment; covalent bonding; entrapment; encapsulation. Various entrapment and encapsulation techniques are known in the art and include entrapment or encapsulation with polymers, within a gel structure, techniques utilizing agar, alginate, k-carrageenan, polyacrylamide, chitosan, gelatin, collagen, polyurethane, silica gel, polystyrene, cellulose triacetate, etc. A worker skilled in the art would appreciate that the choice of immobilization technique will depend on the microbe to be immobilized and the composition and/or manufacture of the biological component support member.

In one embodiment, immobilization is via non-specific absorption.

In one embodiment, the microbial biofilms predominantly comprise microorganisms naturally occurring in the raw water, such biofilms may optionally be established in situ during initialization of the system by pre-running raw water through the system.

As startup time can be slow if biofilms are formed in situ or if microbes need to be acclimated to the raw water; the biofilm may optionally be established using existing microbial cultures that have been previously adapted to specific hazardous wastes thereby decreasing startup and detention times.

### Biological Component Support Member

The design and manufacture of the biological component support member is dependent on the composition and characteristics of the raw water, the biological component, effluent requirements, among other things which would be apparent to a worker skilled in the art.

The biological component support members are generally constructed of a media or material that is resistant to disintegration, ultraviolet degradation, erosion, common acids, alkalies, organic compounds, fungus and biological attack. Such resistance may be integral to the media or material itself or be provided for by various coatings or treatments. In addition to comprising the media, the biological component support member may optionally further comprise various structural or support elements.

Appropriate construction materials are known in the art and include but are not limited to plastic, metal, stainless steel, coated steel, ceramic, polyethylene, polypropylene or combinations thereof and may be rigid or flexible.

The biological component support member may be smooth, porous, textured, webbed, perforated or fibrous, waffled, corrugated, meshed or of open weave structure.

The biological component support member will be sized and shaped to provide maximum surface area for immobilization of the biological components. A skilled worker would appreciate that a variety of shapes would be appropriate including but not limited to multiple individual disks, paddles, crueller-shaped, squares, rectangles, plunger, drum-shaped and fingers.

The biological component support member can be fixed (stationary) or mobile and can include but is not limited to rotating support members, translating sheets, recriprocating sheets, circular disks, plunging support members, screw-like support members, waving support members, paddles, fins, pebbles, microcarriers, webs, screens etc.

In one embodiment, the biological component support is mobile. Mobile biological component supports oscillate, rotate, plunge, swing, sway, translate, or combinations thereof etc.

The biological component support may be positioned such that it is partial submerged or fully submerged within the raw water or may be capable of movement there between. The positioning of the biological component support or movement thereof may be dependent on the biological processes occurring within the cellular system.

For example, partially submerged rotating biological contactors are used for carbonaceous BOD removal, combined carbon oxidation and nitrification, and nitrification of secondary effluents. Completely submerged rotating biological contactors (RBCs) are used for denitrification.

### Movement System

Mobile biological support elements may be hydraulically driven, mechanically driven, gravity driven or air driven. Movement of mechanical driven biological support elements is provided by a motor and drive system and is controlled by actuators. Accordingly, in one embodiment, the cellular system is equipped with a high efficiency motor and drive equipment which has variable speed capability.

In one embodiment the motor is an electric motor. The actual energy requirements for mechanically driven units can be evaluated by taking into consideration the influences of drive train efficiency, recycling needs (such as the need to recycle nitrates), dissolved oxygen requirements, effluent targets, the weight of the biomass, pH requirements, biofilm thickness, media surface area, temperature, and rotational speed.

Air driven cellular system may comprise high efficiency motors and blower systems, which include variable airflow requirements. To evaluate the actual energy requirements for air driven units, the desired rotational speeds, airflow, piping configurations and blower efficiency may be considered.

In one embodiment, the drive system is a compressed air or other gas drive system. Optionally, the compressed air is used to drive buckets or cups arranged on a wheel.

In one embodiment in which an RBC is used, the outer edge of the media plates in a cylindrical assembly is formed to create a bucket of a waterwheel so that power to drive the rotational components is derived from water power acting directly upon the contactor. The contactor in this embodiment is shaped to co-operate with a flow of water to provide the drive torque in the manner of the water wheel. The water power could be generated by a submersible pump sited within the containment vessel.

Optionally, the speed of rotation might be controlled by a mechanical or electrical escapement. Alternatively, the rotor might be driven by air bubbling from beneath causing the buckets to be buoyant. A combination of both air and water drives might also be applied.

Individual biological treatment/processing units may optionally by powered by dedicated motor and have individual actuators or one or more biological treatment/processing units may be powered by a single motor and shared actuators.

Basically any controllable motor or mechanical turning device can be used to provide movement. Appropriate motors and devices are known in the art and include electric motors, motors run on steam, hydraulic motors, air motors, gravity motors, solar power, gases, gasoline, diesel or micro turbines. Optionally, the motors comprise variable speed drives and/or have the ability to operate in forward and reverse directions.

### Sedimentation/Holding/Digestion Tank

The sedimentation/holding/digestion tank is a leak proof tank having one or more raw water inputs through which raw water can be continually or intermittently introduced and one or more clarified liquid outputs in fluid communication with the membrane system. The shape, size and construction of the sedimentation/holding/digestion tank can be tailored for the specific application. Factors to consider when tailoring the sedimentation/holding/digestion include but are not limited to the size of the installation, the quantity of water to be processed, the design and number of biological treatment/processing units, the desired residence time. The sedimentation/holding/digestion tank can be manufactured of any appropriate material including but not limited to concrete, steel, stainless steel, plastic, fiber reinforced plastic and fiberglass.

The sedimentation/holding/digestion tank may be compartmentalized or comprise multiple tanks in fluid communication.

Optionally, the sedimentation/holding/digestion tank may comprise a trough sized and shaped to accommodate the biological treatment/processing units in fluid communication with the tank. In one embodiment, the trough is generally semi-cylindrical in shape with closed ends. The trough may optionally include one or more weir(s) or partition(s) or baffle(s) to divide the trough into two or more treatment/processing zones or compartments with individual treatment/processing zones or compartments sized to accommodate a biological treatment/processing unit.

Trough construction can be manufactured of any appropriate material including but not limited to steel, stainless steel, plastic, fiber reinforced plastic and fiberglass.

Optionally, the holding tank or trough is divided into a series of independent stages or compartments by means of baffles in a single basin or separate basis arranged in stages. Compartmentalization creates a plug-flow pattern, increasing overall removal efficiency. It also promotes a variety of conditions where different organisms can flourish to varying degrees. As the waste-water flows through the compartments, each subsequent stage receives influent with a lower organic content than the previous stage; the system thus enhances organic removal.

In one embodiment, the trough is located in the upper part of the sedimentation/holding/digestion tank with its top level with or higher than the top of the tank. The trough is generally semi-cylindrical shape and has end walls, which may optionally butt up against opposite ends of the tank, or be formed integrally therewith. Optionally, the trough is divided in two or more treatment compartments or zones via partitions with each treatment compartment or zone being provided with a biological treatment/processing unit. The partitions are generally flat and may be manufactured of sheet metal or plastic, etc. The shape and size of the individual partitions being dictated by the shape of the trough.

The sedimentation/holding/digestion tank is sized to accommodate the appropriate amount of raw water and provide appropriate residence time.

The holding tank may further comprise an optional cover. In order to prevent excessive heat gain during the summer, proper ventilation of the insulated covers should be assured.

In one embodiment, the holding tank for the cellular system is also the holding tank for the membrane system.

### Pump

One skilled in the art can appreciate that appropriate pumps or vacuums may be located throughout the system, as required to move the fluids (and sludge) through the B-MIT.

In one embodiment, one or more pumps can be located upstream from the bioreactor. In one embodiment, one or more pumps are located in the rotary zone to increase recycling from the rotary zone back to the primary settling tank. In one embodiment, a pump can be located in the final settling tank to send sludge back to the primary settling tank. In one embodiment, one or more vacuum pumps may be employed to draw the water through the membrane system. In one embodiment, the membrane filtered water product (effluent) output is equipped with a vacuum pump to draw water through the system. Optionally, dosing pumps are included in the system.

### Flow Equalization:

The cellular system may optionally include provisions to step feed, bypass, and isolate individual cellular system stages. Accordingly, if the first stage is being overloaded, this provision will allow a portion of the flow to accumulate or be diverted to alternative low density cellular system stages.

### Biofilm Control

The cellular system may optionally comprise a positive mechanism to strip excessive biofilm growth from the media such as variable speed drives, supplemental air, air or water stripping, or the ability to reverse shaft rotation must be provided.

In one embodiment, microbial growth is optimized to avoid dead zones.

### Means for Optimizing Microbial Environment

A variety of environmental factors can impact cellular system performance and result in seasonal variations in performance. Accordingly, microbial processing of raw water can be facilitated by managing environmental conditions including but not limited to temperature and pH of the raw water, nutrient, organic, vitamin and/or mineral content of the raw water.

To facilitate year-round operation in cold climates, the cellular system may be housed in appropriate insulated structures to protect the biological growth from freezing temperatures and to avoid excessive loss of heat from the raw water. In addition to or alternative to, the holding tank of the cellular system may be insulated and have an insulated cover.

The temperature of the raw water in the cellular system may be elevated using various submerged and/or ambient air heaters known in the art. Such heaters can be powered by oil, gas (including biogas), electric, geothermal, coal, wood, solar panel array, or other source as would be readily understood by a worker skilled in the art.

In addition, the heater may optionally comprise a thermostat or thermocouple and/or a feedback system, which is in response to changes in raw water temperature and thereby maintains the temperature of the water at a pre-determined level.

The biological digestion of contaminants within the raw water may result in the production of by-products that affect the pH of raw water and thereby impact biofilm health. Accordingly, in one embodiment, the cellular system further comprises a system for measuring and controlling the pH of the water. Such a system may include one or more pH probes for measuring pH at various locations within the system and one or more inputs for adding acidic or basic compounds as required. In one embodiment, the system comprises one or more pH probes mounted in the cellular system, a pH isolater/amplifier and computer running appropriate software and one or more a dosing pump for adding acidic or basic components.

In one embodiment, the inputted raw water is supplemented with a medium/reagent to increase buffering capacity. Appropriate buffering medium/reagents are known in the art and include phosphate buffer, sodium carbonate, sodium bicarbonate, citrate-phosphate buffer, borate buffer, etc.

In addition, the cellular system may further comprise a variety of equipment for monitoring various conditions within the raw water including sensors for monitoring raw water temperature, dissolved oxygen levels, flow meters, pH meters, in-line contaminant meters, on-line or off-line contaminant monitoring meters, etc.

The addition of various chemicals and additives can enhance many raw water treatment processes. For example, denitrification of raw water can be enhanced by the addition of an external carbon source, appropriate carbon sources are known in the art and can include methanol, sodium acetate, molasses, acetic acid, and refined sugar.

Accordingly, the raw water may optionally be supplemented with various additives including but not limited to enzymes, biological and chemical catalysts, such as nitrifying and denitrifying, carbon or electron donor sources, nutrients, vitamins or minerals. Accordingly, the cellular system may optionally comprise one or more systems for inputting such additives.

### Optimizing for Nitrification/Denitrification Processes

The system may be specifically adapted to promote nitrification or denitrification processes.

Nitrification is achieved by fixed film Nitrosomas and Nitrobacter. Denitrification is achieved either by fixed film or suspended denitrifiers or by a combination of both. Accordingly, in one embodiment, the biofilms are specifically adapted for nitrification or denitrification.

The nitrification reaction begins when the carbonaceous bacteria have brought the BOD concentration low enough, i.e., around 30 mg/l. Further BOD removal takes place through the action of the nitrifiers. In the nitrification reaction (NH₄⁺+2HCO₃⁻+2O₂→NO₃⁻+2CO₂+3H₂O), ammonia is oxidized first to nitrite and then to nitrate by Nitrosomonas and Nitrobacter, respectively. Nitrification is pH sensitive and rates decline significantly below pH 6.8. Also, as shown by the stoichiometry of the reaction, sufficient alkalinity must be present for the nitrification reaction to occur. Accordingly, in one embodiment, the system comprises means for monitoring and controlling pH and for monitoring and controlling alkalinity.

Denitrification is the biological process though which nitrate nitrogen is converted into nitrogen gas (NO₃⁻→NO₂⁻→NO→N₂O→N₂). Indeed, nitrate is reduced to nitric oxide, nitrous oxide and then finally nitrogen gas in an anoxic environment. Since most of the influent carbon is used in the aerobic portion of the process, supplemental carbon may be required to provide a carbon source to the denitrifying bacteria. Adequate supplemental carbon sources are soluble biodegradable organic carbon products such as sodium acetate, methanol, acetic acid, or refined sugar. Using methanol as an example of suitable organic source, the stoichiometry of the reaction is as follows: 5CH₃OH +6NO₃⁻→3N₂+5CO₂+7H₂)+60H⁻. Accordingly, in one embodiment, the system comprises means for adding supplemental carbon.

### Phosphorus Reduction

The cellular system may further comprise phosphorus reduction capabilities.

The removal of phosphorus is achieved to very low Total Phosphorus (TP) concentrations (<0.03 mg/l) by combining the Phys-Chem-Bio process to an effective physical retention of precipitated material by the MF/UF membrane. TP is removed both through biological action and by chemical precipitation followed by physical retention of the particulates.

In one embodiment, phosphorus reduction can be achieved by dosing the raw water with coagulants that react with phosphates to form insoluble precipitates. The precipitates settle to the bottom of the treatment chamber and the phosphorus concentration in the water is effectively reduced. Appropriate coagulants are known in the art and include but are not limited to metal oxides such as calcium, magnesium, or sodium aluminate, or by the addition of inorganic coagulants such as certain soluble salts containing multivalent cations, such as aluminum sulphate, ferrous sulphate, ferric sulphate, ferric chloride, sodium aluminate and calcium hydroxide. Accordingly, the cellular system may further comprise inputs for adding such coagulants.

In one embodiment, phosphorus reduction is achieved by adding a suitable amount of an aluminum-based coagulant/flocculent to the raw water while maintaining a pH of between about 4.5 and 6.65. The aluminum-based coagulant/flocculent may be added continuously or intermittently, from one input or from multiple input space throughout the cellular system. This step provides an eventual effluent stream of precipitated aluminum-based, phosphorus-containing flocs dispersed in the raw water that are suitable for removal by physical means such as filtration. A worker skilled in the art would readily appreciate that a variety of filters including a filter bed (including continuous self-cleaning sand filter beds) or a polymeric membrane, or a ceramic membrane, including sand or multi-media filters or micro-ultra-filtration membranes may be employed to remove the flocs.

Appropriate aluminum-based coagulant/flocculent are known in the art and include but or not limited to polyaluminum silicate sulfate, polyaluminum silicate chloride, polyaluminum hydroxychlorosulfate, and polyaluminum chloride.

In one embodiment, the aluminium-based coagulant/flocculent is maintained within the range of from about 300 mg/L to about 800 mg/L of raw water.

In one embodiment, the pH is maintained through the addition of a suitable acid. Suitable acids are known in the art and include but are not limited to sulphuric acid, hydrochloric acid, acetic acid or citric acid.

Alternatively, the phosphorous reduction capabilities may be contained in a separate module within the cellular system. In one embodiment, the first module of the cellular system which receives raw water from the PST or other source is a phosphorous reduction module.

### Process Additives

In one embodiment, the cellular system comprises one or more process additive inputs. Process additives include membrane compatible polymers, membrane performance enhancers, supplemental carbon sources, coagulant/flocculent, buffers, conditioners etc.

In addition, as research (Nagaoka et al, 1996, 1998; Lee et al., 2002) has shown that one of the main causes of membrane fouling is biopolymer, which includes polysaccharides and proteins secreted by the biomass, in some embodiments, it may be desirable to reduce or remove biopolymer from the water. Biopolymers secreted from the biomass may be coagulated or flocculated using polymers known in the art including MPE30 and those described in U.S. Pat. No. 6,723,245, U.S. Pat. No. 7,378,023 and WO2008/033703. Accordingly, in one embodiment, the water in the bioreactor is conditioned by adding an effective amount of at least one water soluble cationic polymer.

### Sludge Removal

In one embodiment, the cellular system further comprises a system for handling sludge. Such systems are know in the art and can include systems for removing accumulated sludge or systems for minimizing sludge accumulation.

In one embodiment, the sludge removal system comprises a vacuum pipe or hose with one or more suction points located close to the holding tank floor, such that the sludge is removed from the holding tank. Optionally, the vacuum pipe or hose is fixed in position or is movable over all or part of the floor of the holding tank. The sludge removal system can operate either continuously or intermittently. Intermittent operation may be programmed or responsive to sludge levels. Accordingly, the holding tank may optionally be equipped with a sludge level gauge or sensor. The sludge removed can be further processed by, for example, mixing with raw water prior to re-input into the cellular system or via anaerobic or aerobic bacterial digestion. Accordingly, the B-MIT can further comprise anaerobic or aerobic sludge digestion system. Alternatively, the removed sludge can be disposed of or recycled by means known in the art including for example (1) application to land as soil conditioner or fertilizer, disposed on land by placing it in a surface disposal site, placed in a municipal solid waste landfill unit, or incinerated.

The biological processing of raw water may result in the production of biogas including methane. Accordingly, in one embodiment, the cellular system further comprises a biogas collection and/or flare system. The biogas produced from the cellular system can optionally be flared thereby further reducing odors and emissions of methane. Alternatively, the biogas can be recycled for use in an application such as a heating unit that can be used to heat the cellular system or associated buildings or to a generator to create electricity for use in the treatment process, the facility or an outside application.

### The Filtration System

Following processing in the bioreactor, the biologically processed water is filtered by the filtration system. The filtration system is functionally integrated with the bioreactor such that output or feed quality from the bioreactor (i.e. the biologically processed water quality) impacts the functioning of the filtration system. Optionally, this functional integration may be responsive to the quality of the biologically processed water.

The functional integration of the bioreactor and filtration systems may provide for one or more of the following: higher, more constant permeate flux; less irreversible and reversible fouling of the membranes; lower power requirements; lower or less frequent aeration; straightforward process for cleaning the membrane and an overall simpler process.

The filtration system is designed to i) input the biologically treated water to be filtered, ii) remove particles, solids and microorganisms from the biologically treated water, and iii) output an effluent of a minimum acceptable quality. The filtration system may further be designed to limit the dependence on post treatment disinfection with UV and chlorine by utilizing membranes having pores sized to trap a significant proportion of pathogenic organisms.

Optionally, the filtration system may be designed only to accept biologically processed water meeting minimum quality threshold. Water not meeting this minimum quality threshold can be retained by or recycled back to the bioreactor or diverted for further pre-membrane treatment. Accordingly, in one embodiment, the B-MIT is equipped with appropriate sensors and effectors for testing and diverting water.

In one embodiment, biologically water having a Total Suspended Solids (TSS) concentration greater than 100 mg/l; and a Biochemical Oxygen Demand −5 days (BOD₅) concentration greater than 100 mg/l is re-circulated into the bioreactor for further processing or is diverted for a series of pre-membrane clarifying or filtration steps. In one embodiment, biologically water having a Total Suspended Solids (TSS) concentration greater than 50 mg/l; and a Biochemical Oxygen Demand −5 days (BOD₅) concentration greater than 50 mg/l is re-circulated into the bioreactor for further processing or is diverted for a series of pre-membrane clarifying or filtration steps.

The filtration system comprises one or more membrane units housed within one or more membrane tanks. Optionally, the membrane tank is a downstream compartment or region of the decomposition tank. In embodiments with two or more membrane units, the membrane units may be configured in a parallel or serial arrangement or parallel arrangement of two or more serially connected membrane units. In such parallel arrangements of serially connected units, each series may optionally be specifically designed to accommodate a specific starting quality of biologically processed water. In addition, feed to individual series may be regulated based on the quality of the biologically processed water. To provide for such regulation, the B-MIT may be equipped with appropriate sensors to measure the quality of the biologically processed water and appropriate effectors to direct biologically processed water flow to the appropriate series.

During processing, the biologically processed water flows through the one or more membranes. Solid material larger than the threshold of the membrane type (e.g., nano filtration, ultra filtration (UF), microfiltration (MF)) is retained by the membrane and the filtered water passes through. The UF or MF membranes utilized by the B-MIT have pore sizes such that water and most soluble species pass through the membrane while other larger species, such as suspended solids and microorganisms are retained. The filtered water exits the membrane into one or more outlet tubes. The one or more outlet tubes optionally feed into one or more outlet pipes that can feed storage tanks or downstream applications.

Flow through the membrane can be active or passive. In embodiments in which simplification of the system or savings in energy consumption are desirable, passive filtration may be preferred over active filtration.

Active flow through the membrane can be achieved by the use of a suction pump. The suction necessary to facilitate flow through the membrane will depend on several factors including the quality of the inputted biologically processed water, membrane configuration and the membrane threshold. Optionally, the suction pump may be solar powered or powered by biogas.

Passive flow can be achieved by operating the filtration system in a gravitational flow mode with available pressure resulting from the head of the biologically processed water. During gravitational filtration, the permeate stream is pushed from the bulk solution side by a pressure head over the membrane module.

Using the water level of the tank, the transmembrane pressure (TMP) can be maintained at a specified level. Optionally, the pressure can be controlled by modulating the water level of the head. In one embodiment, water level may be controlled or maintained at a constant level by use of a pump. Accordingly, the tank may be equipped with one or more sensors to measure water level and various effectors responsive to changes in water level. The pump may optionally recycle effluent in order to maintain a constant water level.

The filtration system may be adapted to operate using both suction and gravitational flow modes.

The filtered water exits the system as the effluent, which is optionally subjected to further treatment. Further treatment may include UV disinfection or chlorination.

### Filtration System Design Considerations

Several factors may be considered when designing an appropriate filtration system to meet the system requirements of the B-MIT and provide effluent of a minimum quality. Primary design considerations include the quality and temperature of the biologically processed water, membrane configuration, membrane pore size, filtration mode (active or passive), aeration rate, permeate flux, fouling and scaling considerations. A worker skilled in the art would appreciate that there are various computer programs available to facilitate the sizing of membranes. Additional design considerations can include capital and operating costs.

Various types of membrane configurations are known in the art that would be appropriate for use in the B-MIT and included both submerged and external membrane configurations. Submerged membrane configurations include flat sheet/plate and frame and hollow fiber configurations.

Several factors may be considered when choosing an appropriate membrane configuration to meet system requirements and to provide effluent of a minimum quality. These factors include but are not limited to available membrane pore sizes in a specific membrane configuration, packing density, fouling propensity, permeability and energy consumption. Generally, external configurations may be desirable if there is a high propensity for fouling of the membrane. The submerged configurations are generally more energy efficient.

A worker skilled in the art would appreciate that fouling propensity, permeability, flux and transmembrane pressure are dependent on membrane configuration and, as such, the filtration system may be optimized to account for the effect of the membrane configuration. For example, previous studies have demonstrated that with lower aeration, a flat plat system yielded a permeability twice that of a hollow fiber. Accordingly, in order to increase hollow fiber unit permeate flux, the frequency of backwashing and chemical cleaning may optionally be increased in B-MIT utilizing hollow fiber membrane systems.

If a hollow fiber membrane is utilized, another factor for consideration in the design of a membrane system is the fiber configuration, packing density and fiber width. Various hollow fiber membrane configurations are known in the art, for example see Shimizu et al. (1996). The configurations can include a Type A configuration which is a bundle of elements folded to meet at both ends and then ends cut and fixed to collect filtrate; a Type B configuration which is folded ends dispersed by a wire frame, a Type C configuration which is folded ends cut and separately sealed by theunal treatment to move individually and a Type D configuration which is folded elements aligned two rows and cut ends fixed to seal. One of skilled in the art would appreciate that the hindrance coefficient and flux values is dependent on configuration.

A further consideration when designing the filtration unit is the pore size of the membranes. The relative size of the pores in the membrane filter can be varied depending on the quality of raw water desired. By changing the pore size of a membrane in a filtration system, different components are allowed to pass through the membrane and different components can clog the membrane pores. This changes the fouling profile of a system as well the permeate flux and TMP. Pore size can range from 2 microns (micro filtration) to 0.0001 microns (reverse osmosis filtration) in diameter. Smaller pore diameter will require the creation of greater raw water pressure to force the raw water through the membrane and may also require more frequent cleaning.

In one embodiment, the membrane material comprises a plurality of pores having a diameter that is between 0.08 and 0.4 microns.

### Membranes Units

The filtration system provides one or more membrane units for separating water from contaminants such as suspended solids or bacteria from the biologically processed water.

Each membrane unit comprises one or more semi-permeable membranes affixed to a support or header. Optionally, membrane units comprise two or more membranes arranged in close proximity to one another and mounted so as to prevent excessive movement therebetween.

The membrane unit also comprises an outlet tube, operatively associated with the membrane unit to receive filtered water and conduct it from the membrane tank. The outlet tubes of one or more membrane units may optionally feed into an outlet pipe to conduct filtered water from the membrane tank to the next stage in the treatment process, if further treatment is warranted.

A variety of different types of membrane constructions can be used in the membrane system of the present invention without departing from the scope of the invention. Membrane configurations can include, for example, thin-film composite membranes featuring one or more layers of filtering material such as, for example, synthetic polymers, polyamide, polyamide layered with polysulfone, polyvinylidenedifluoride, zeolites, as well as thin film nano-composite membranes, and the like.

Suitable membrane units are known in the art and can be procured from companies such as Toray Membrane, Zenon. Exemplary commercially available membranes that are applicable to the M-BIT include but are not limited to those listed in Table 1.

TABLE 1
Submerged Membrane Suppliers

| | | Membrane |
|---|---|---|
| Company | Product Name(s) | Configuration |
| Toray Group | Submerged Membrane | Flat Sheet |
| | Modules | |
| Weise Water Systems | MicroClear filter | Flat Sheet |
| GmbH & Co KG | | |
| Kubota Corporation | KUBOTA Submerged | Flat Sheet |
| | Membrane Unit | |
| Koch Membrane Systems | PURON ® Submerged | Hollow Fiber |
| Inc. | Hollow Fiber | |
| USFilter (Siemens Water | AXIA ® Small Range | Hollow Fiber |
| Technologies) | Systems - AXIA ™ | |
| | Submerged Microfiltration | |
| | System in Packaged | |
| | Configuration PreMPT ™ | |
| | Containerized System | |
| Mitsubishi Rayon Co. Ltd. | STERAPORESUN ™ and | Hollow Fiber |
| | STERAPORESADF ™ | |
| Zenon Environmental (GE) | Zeeweed 500, 1000, | Hollow Fiber |
| | Tertiary UF | |
| Triqua (part of Delta) | SubTriq ® | Flat Plate and |
| | | Hollow Fiber |

In one embodiment, the filtration system comprises one or more plate and frame membranes submerged at the downstream end of the decomposition tank. The plate and frame membranes comprise flat sheets of membrane material mounted on a frame so as to define an interior space to separate permeate from the unfiltered biologically processed water. In one embodiment, a plurality of plate and frame membranes is mounted at a fixed distance to one another to create a membrane unit.

In one embodiment, the filtration system comprises one or more non-submerged membrane units. Various non-submerged membrane configurations are known in the are and include hollow fiber configurations comprising a plurality of porous hollow fibre membranes, and spiral-wound membranes consisting of two layers of membrane, placed onto a permeate collector fabric. This membrane envelope is wrapped around a centrally placed permeate drain. Non-submerged membranes generally comprise an inlet header having one or more apertures formed therein through which liquid to be filtered is introduced, a central portion containing one or more membrane filters, and second header being an outlet header having one or more outlet tubes operatively associated with said one or more membrane filters so as to receive permeate. The outlet of the bioreactor is operatively coupled to the inlet header.

In one embodiment, the filtration system comprises one or more membranes having a strong mechanical motion including cross oscillation, lengthwise oscillation and vibration.

In one embodiment, the filtration system comprises one or more membranes having a rotary disc membrane configuration. Optionally, the rotary disc membrane is a vibratory shear enhanced processing (VSEP) membrane. VSEP membranes are known in the art and include those supplied by New Logic Research, Inc.

In one embodiment, the filtration system comprises one or more submerged membranes with cross oscillation. In one embodiment, the filtration system comprises one or more submerged membranes with lengthwise oscillation.

### Membrane Tank

The membrane units of the filtration system are housed within one or more membrane tanks that are sized to contain a specified quantity of biologically processed water. The shape, size and construction of the membrane tank can be customized, depending on the size of the installation, the type of filtration system employed (i.e. active or passive), the quantity of water to be processed and the industrial application for which the system is designed. The membrane tank may optionally be the same as or continuous with the sedimentation/holding/digestion tank.

In embodiments in which gravitational flow is employed, the height of the tank and the amount of water above the membrane unit corresponds to the pressure head and is the driving force for the filtration process. Optionally, a water level of 0.5 m corresponds to a TMP of 4.9 kPa, a water level of 1 m corresponds to a TMP of 9.8 kPa, a water level of 1.5 m corresponds to a TMP of 14.7 and a water level of 2 m correspondes to a TMP of 19.6 kPa.

The membrane tank can be constructed out of various materials including but not limited to concrete, metal including steel and stainless steel, plastic such as high density polyethylene, fiber reinforced plastic, fiberglass, and the like.

The membrane tank comprises one or more inlets for raw water to enter the membrane tank. The biologically processed water passes from the bioreactor into the membrane tank through a gravity system.

The membrane tank comprises an outlet for the removal of sludge from the membrane tank.

The system comprises two or more modular membrane tanks. The modular membrane tanks can be coupled to the bioreactor either in series (for example, to provide graded levels of filtration) or in parallel (for example to provide additional capacity or to provide the capability to empty one tank for maintenance purposes) as necessary. The use of modular tanks creates the capacity to scale up or down the raw water treatment system.

### Cleaning System

Accumulation of contaminants and biofilm on the surface of the membrane is a known problem with membrane filtration systems. This accumulation impairs the function of the membranes and can reduce their lifespan.

Various means of further reducing contaminant in membrane systems, such as treatment of the raw water with flocculant promoting substances or substances to promote further digestion of contaminants in the membrane tank.

The water in the membrane tank can be treated with substances to prevent biofilm accumulation, such as, for example, chemical treatment of the water in the membrane tank. Any substances such as sodium hypochlorite or citric acid can be used to treat the water should not result in the introduction of undesirable particles that could pass through the membrane or the degradation of the membranes themselves.

The membranes can be kept free of biofilm by raising the temperature of the raw water prior to entering the membranes to the point where it kills organisms that would otherwise foul the surface of the membrane.

The membrane tank comprises a cleaning system to remove accumulated biofilm and contaminants from the surface of the membrane. The cleaning system for the membrane units may be optimized for the specific membrane configuration. Various means of cleaning the membranes are known in the art and include coarse bubble aerators, vibrators, centrifugal force, water sprays, supplemental gas treatment or chemical cleaning. In one embodiment, the cleaning system comprises a coarse bubble aerator or diffuser associated with the membrane units such that the rising bubbles dislodge contaminants and biofilm from the membrane surface. Optionally, the aeration rate can be optimized to maximize permeate flux. In one embodiment, the aeration rate will be the critical aeration rate above which no improvement of permeate flux with time occurs. A worker skilled in the art would appreciate that the value of the critical aeration rate will depend on the membrane area and can be readily determined.

If appropriate for the specific membrane configuration, the membranes may also be subject to backwash with permeate for specified periods of time at regular intervals. In one embodiment, the backwash with permeate is for 20 seconds every 3 to 5 minutes. In one embodiment, the backwash with permeate is for 50 seconds every 5 minutes.

Optionally, the cleansing system comprises one or more motorized lifting units operatively associated with the one or more membrane units. In operation, the one or more motorized lifting units gently shake the membrane units to create a shearing force to dislodge any contaminants or biofilm. Such cleansing system may be operated intermittently so as not to impair the function of the membrane units.

If non-submerged membranes are used for filtration alternate cleaning system such as backwashing with liquid and/or gas will be used.

### Sludge Management System

While the B-MIT will act to remove suspended organic contaminants in the raw water, some buildup of sludge on the bottom of the membrane tank may occur. Sludge and suspended solids arise from: primary clarification, the biological treatment (dead biomass).

Accordingly, a sludge removal system is optionally provided. The cellular system further comprises an optional system for handling sludge which can include systems for removing accumulated sludge or systems for minimizing sludge accumulation.

The sludge removal system comprises a vacuum pipe or hose with one or more suction points located close to the holding tank floor, such that the sludge is removed from the holding tank. Optionally, the vacuum pipe or hose is fixed in position or is movable over all or part of the floor of the holding tank. In operation, the pump sucks the sludge through the sludge removal pipe, which can be fixed in place or moveable about the membrane tank. The sludge can then be removed offsite or returned upstream to the bioreactor or a pre-treatment unit for further processing. The sludge removal system could be used intermittently so as not to disturb the operation of the membrane units. Accordingly, the holding tank may optionally be equipped with a sludge level gauge or sensor.

The sludge removal system may comprise a sludge outlet located close to the base of the membrane tank. The sludge outlet is scalingly connected to a sludge removal pipe. The sludge removal outlet can be opened and closed so as to control the removal of sludge from the membrane tank. When the sludge removal outlet is opened, sludge moves from the tank, through the sludge removal pipe by system of gravity. According to one embodiment, the sludge removal pipe is operatively associated with a pump for drawing sludge from the membrane tank.

The removed sludge can be further processed by, for example, mixing with raw water prior to re-input into the cellular system or via anaerobic or aerobic bacterial digestion. Accordingly, the B-MIT can further comprise anaerobic or aerobic sludge digestion system. Alternatively, the removed sludge can be disposed of or recycled by means known in the art including for example application to land as soil conditioner or fertilizer, disposal on land by placing it in a surface disposal site, such as a municipal solid waste landfill unit, or incineration.

The sludge removal pipe is sealingly connected to a sludge inlet in the bioreactor. According to one embodiment, a pump is operatively associated with the sludge removal pipe to remove sludge from the membrane tank and conduct it to the bioreactor.

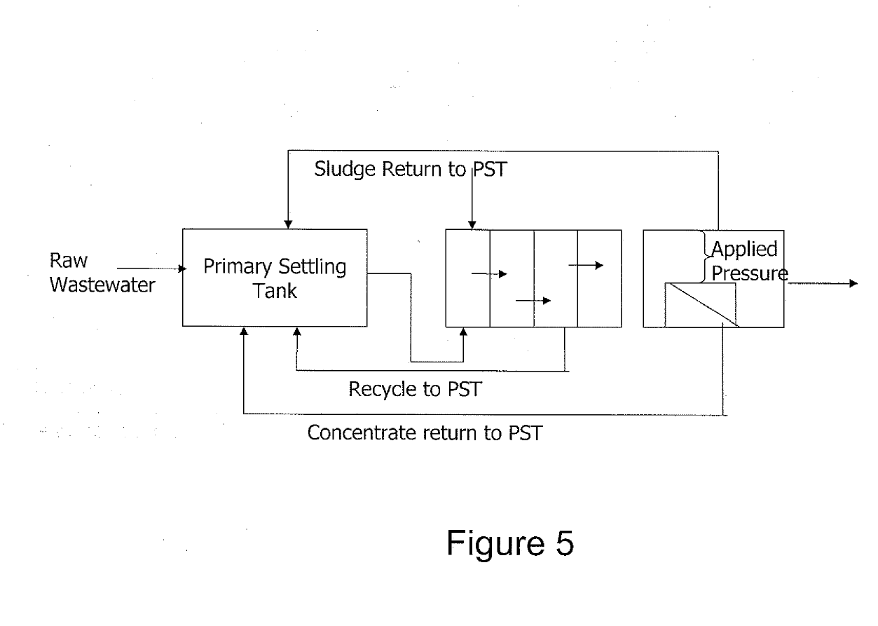

Referring to FIG. 5, in one embodiment, sludge is in part directly returned to the primary clarifier but in part fed directly to the membrane system (which is preceded or not by a secondary clarifier), solids remaining on the retentate (as opposed to the permeate) side of the membrane. Optionally, all sludge and suspended solids removed from the treated water by the system are returned to the primary clarifier (PST) for storage. If a secondary clarifier (FST) is used, the sludge accumulating there may optionally be pumped back from the bottom of that tank to the PST. As air is buddle into the membrane tank, the solids which end up on the retentate side of the membranes do not settle, to prevent a constant raise of their concentration fluid from the retentate side (i.e., from the main membrane tank) is constantly returned to the PST (or FST).

### Diagnostic and Control System

The B-MIT may optionally comprise a diagnostic and control system for the periodic or real-time monitoring of the water as it passes through the technology. The diagnostic system comprises one or more sensors such as, for example, temperature, pH, raw water level, sludge level, flow rate, water pressure, dissolved oxygen, and water quality sensors. In addition, the diagnostic system may further comprise one or more sensors which measure direct or indirect indicators of biological processing, for example sensors may measure methane (CH₄), carbon dioxide (CO₂), hydrogen sulfide (H₂S), gaseous ammonia (NH₃) and atmospheric oxygen (O₂) levels as an indirect measure of biologically processing.

In one embodiment, turbidity is monitored in real-time in the effluent of the biological process as an indicator of the suspended (and/or colloidal) solids concentration. Optionally, this parameter is corrected in real-time by adjusting coagulants and flocculants dosing.

The sensors may be distributed throughout the different tanks that make up the system. A worker skilled in the art will appreciate the optimal location for different types of sensors to maximize the quality of the sensing data collected. According to one embodiment, sensors are placed to measure the quantity and quality of water exiting the treatment system. The sensors may optionally produce results in a format that can be transmitted to and interpreted by a central computing device.

The central computing device may be operatively connected to systems for adjusting the different qualities measured by the sensors based on the information received from the sensors or in response to specific triggers. For example, the central computing device could be operatively connected to a temperature sensor and a heating device. Triggers may include a drop in water pressure in the outlet pipe of the filtration system resulting in the automatic activation of a cleaning system within the membrane tank or a change in sludge levels resulting in the automatic activation of the sludge removal system.

According to one embodiment, the internal conditions in the raw water treatment system can be adjusted to optimize growth of organisms in the Immobilized Cell System and, therefore, digestion of particles in the raw water.

### Applications

The B-MIT is a raw water treatment system for the treatment of raw water including, but not limited to, municipal raw water and wastewater, commercial raw water and wastewater (e.g. malls, restaurants), leachate treatment, toxic waste, industrial raw water (automotive industry, mining, pulp and paper, oil industry; pharmaceutical raw water, farming raw water (i.e. ammonium removal from livestock raw water, large scale food preparation raw water), food industry wastewater (e.g. dairy, food processing) and the like.

The B-MIT can be used to process water for various uses including but not limited to irrigation of food or non-food crops, park and playgrounds, golf courses, cemeteries, public and private lands, recreational impoundments, landscape impoundments, decorative fountains, supply for cooling or air conditioning, groundwater recharge, surface water discharge, flushing toilets and urinals, priming drain traps, industrial process water, fire fighting, laundries, commercial car wash, industrial process water, boiler feed, mixing concrete, artificial snow making, soil compaction, dust control on road and streets, cleaning roads, sidewalks and outdoor areas, flushing sanitary sewers, amongst other uses.

The system comprises a bioremediation step in the form of an immobilized cellular system that promotes the growth of biological organisms on a surface, which in turn digest contaminants within the raw water. Optionally, organisms are selected to encourage the generation of useful byproducts, such as, for example, methane, hydrogen, microbial cellulose, bioethanol and the like. According to one embodiment the system comprises scaled tanks with collection means to capture such useful byproducts.

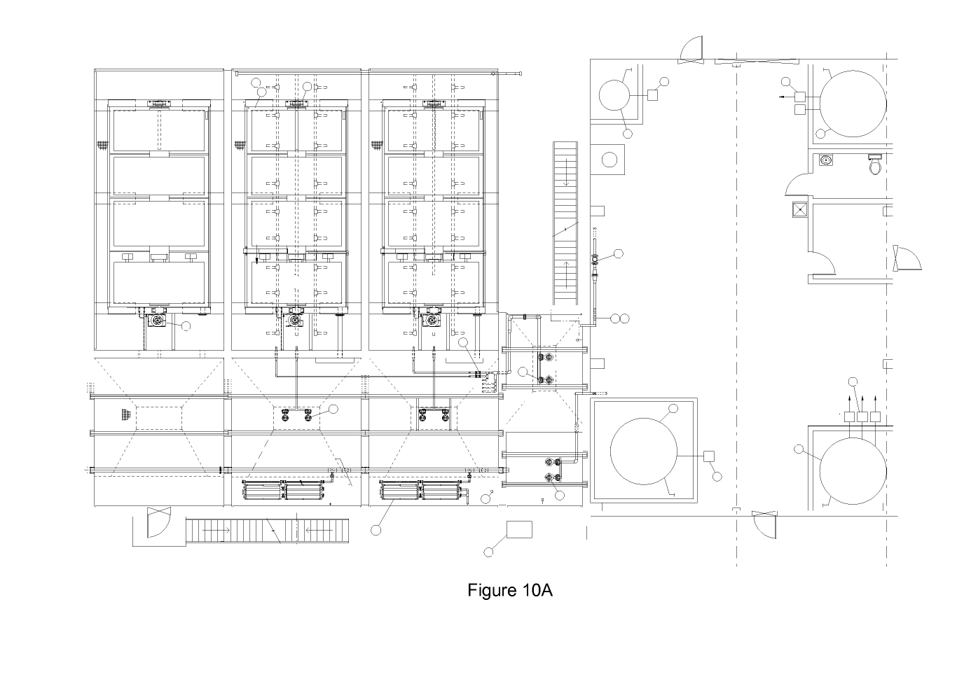

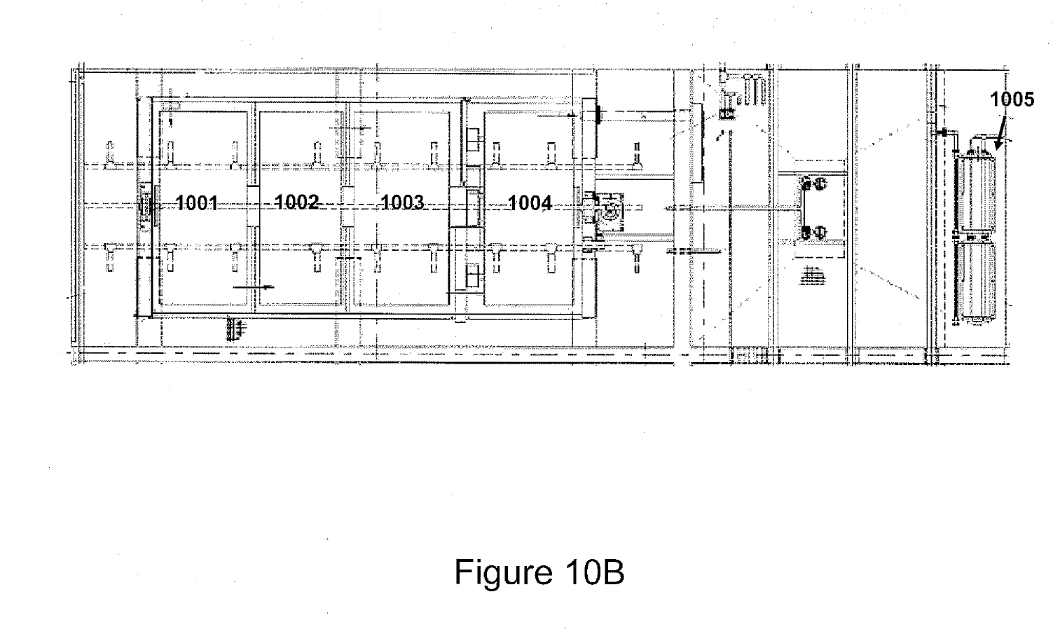

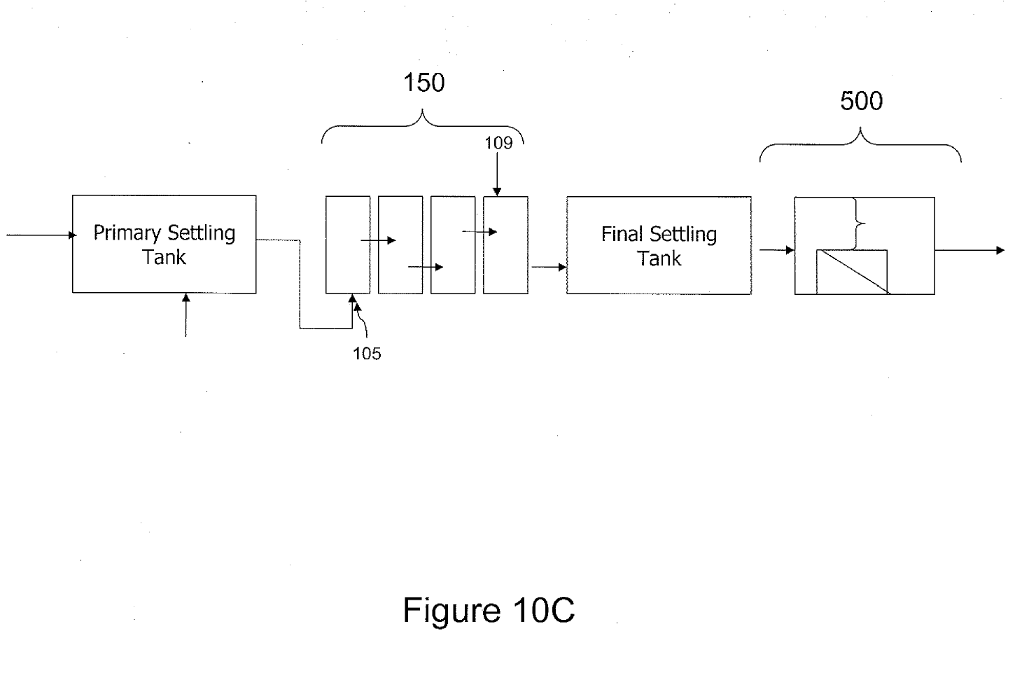

The integration of the bioreactor with the membrane system in the B-MIT provides for a treatment that achieves high effluent quality with a small design footprint. The B-MIT is scalable such that multiple B-MIT may provide for large capacity. For example, referring to FIG. 10A, multiple B-MIT strings may provide for a larger capacity. A worker skilled in the art would readily be able to determine the number of strings required to achieve a specific capacity.

In addition, the B-MIT is amendable to downsizing to a portable size suitable for treating smaller amounts of raw water. Examples of applications for such a smaller system include, for example, shipboard treatment systems, systems for use in recreational vehicles, cottages or aquariums.

The B-MIT can be housed within a building, structure or shell and can be readily camouflaged facilitating its placement in populated areas or communities as it is virtually odorless. Portable B-MITs may be housed within a box, casing or shell that is optionally equipped with wheels or rollers to facilitate movement.

The housing of the B-MIT can be further equipped with solar panels which may optionally feed electricity into the local power grid or power the process. The process may also be powered by other alternative energy sources including, for example, wind power, hydroelectric and geothermal power.

Alternatively, the B-MIT may be housed fully or partially underground.

Optionally, the B-MIT may be a sealed system to contain odors or fumes resulting from the raw water or processing thereof.

The B-MIT is amendable for use in a variety of settings including, for example, trailer parks, camps, mining sites, forestry sites, petroleum products extraction sites, hotels, resorts, remote locations, islands, wineries, farms, domestic, industrial, commercial, construction, mines, diaries, bakeries, pulp and paper facilities, military and manufacturing sites.

### Process

The raw water is treated according to the following process.

The raw water enters the systems and maybe subjected to an optional pre-treatment/pre-conditioning step. The raw water pre-treatment step can comprise mixing, shredding, UV irradiation, ozonation, heating, cooling, adjusting composition or pH, chemical treatment, flocculation, primary settling, filtering and the like. A bar screen, grit chamber or rotary drum screen may be used to achieve coarse solids removal. Suspended solids that are not removed during course solids removal may be removed using a sedimentation tank or a clarifier. Optionally, coagulants such as alum, poly aluminum silicate sulfate, ferric chloride or Epi-DMA and an anionic flocculant, such as a co-polymer of acrylic acid and acrylamide, are used in the sedimentation tank or clarifier to remove additional solids.

A worker skilled in the art would appreciate that the composition of the pre-treatment step will depend upon the quality of the raw water being added to the system. For example, a worker skilled in the art would appreciate that in industrial plants where synthetic oils are present in the untreated wastewater, such as an oil refinery, pretreatment to remove oil may be necessary and can be accomplished in units such as the inclined plate separator and the induced air flotation unit (IAF). Optionally, a cationic flocculant, such as a co-polymer of DMAEM and AcAm, is used in the IAF unit to increase oil removal.

The pre-treatment step may also comprise an assessment of raw water quality prior to treatment. For example, pH testing can be conducted to determine whether adjustment is desirable or required.

In the next step, the raw water is treated with one or more isolated cellular systems wherein the raw water is brought into contact with microorganisms that digest organic contaminants within the raw water thereby obtaining a biologically processed water. Subsequent to this stage, the biologically treated water separates into lighter and heavier elements, with heavier elements settling to the bottom of the container and forming a thicker sludge layer. Optionally, various process additives may be inputted into the water.

This step may comprise real time monitoring of water quality and characteristics. The information produced by the monitoring may be used to adjust the conditions to optimize raw water treatment and/or growth of microorganisms.

In one embodiment, the biologically treated water is conditioned by adding an effective amount of at least one water soluble cationic polymer to coagulate biopolymer.

The biologically processed water exits the one or more isolated cellular systems and optionally subjected to a post-treatment step. This step can comprise, for example addition of enzyme for further bioremediation, temperature adjustment, treatment with ultraviolet light, chlorination, ozonation, filtering and the like to obtain a biologically processed water of a minimum quality of a Total Suspended Solids (TSS) concentration equal to or less than 100 mg/l; and a Biochemical Oxygen Demand −5 days (BOD_{S}) concentration equal to or less than 100 mg/l. According to one embodiment, this step comprises a monitoring and testing step the results of which determine which post-treatment is necessary.

The biologically processed water of a minimum quality flows into the filtration system thereby obtaining an effluent. The effluent exits the membrane in one or more outlet tubes, which feed into an outlet pipe.

If necessary, the effluent is subjected to a final post-treatment step. Such a step can comprise, for example, ultraviolet radiation treatment, chlorination, ozonation or other chemical treatment, further filtration through a finer membrane (such as a reverse osmosis membrane filter) and the like.

The resulting water product can then be disposed of through a disposal system such as being pumped into an aquifer, surface water, natural or manmade wetlands and the like. According to one embodiment, the treated water is recycled for use in industrial or agricultural applications such as irrigation. According to one embodiment, the treated water is recycled into the water system for drinking purposes.

### Modularity of the B-MIT

Optionally, the B-MIT is modular in design and, as such, is readily adaptable to many applications. The modular bioreactor comprises one or more modular cellular systems and a modular membrane system in fluid communication. The components of the modular cellular systems may be prefabricated units adapted for interconnection there between. A worker skilled in the art would appreciate that the number of individual modules and their arrangement would, in part, depend on the characteristics of the raw water, system and site requirements and minimal quality requirements of the effluent water product as dictated by downstream applications or environmental regulations. In one embodiment, the modular design provides for redundancy in the system or allows for the addition of pre- and post-treatment modules.

In one embodiment, the modular cellular system component of the bioreactor comprises a series of self-contained holding tanks in fluid communication, wherein each holding tank is equipped with at least one fixed-growth biological treatment unit. The number and type of individual modules of the cellular system depend on the raw water characteristics and minimal quality of effluent acceptable to the first or upstream module of the membrane system component.

The bioreactor may be designed to comprise one or more distinct modular cellular systems, depending on system requirements and applications, with individual cellular system modules being adapted to support specific biological processes including but not limited to carbonaceous oxidation, nitrogenous oxidation, biological denitrification and phosphorus removal. In one embodiment, the ordering of the individual modules is such that the processes occurring within the upstream module facilitate or optimize the processing occurring within the downstream modules.

In one embodiment, the bioreactor comprises one or more aerobic cellular system modules in fluid communication with one or more anaerobic or anoxic cellular system modules.

In one embodiment, the bioreactor comprises alternating aerobic and anaerobic/anoxic cellular system modules.

In one embodiment, the bioreactor is a modular rotating biological contractor (RBC).

The modular membrane system may comprise one or more distinct module designs, depending on quality of the biologically processed water, the system requirements and downstream applications of the effluent water product, with individual modules being self-contained filtration units.

In one embodiment, the membrane system is housed in a downstream section of the bioreactor holding tank.

### EXAMPLES

### Example 1

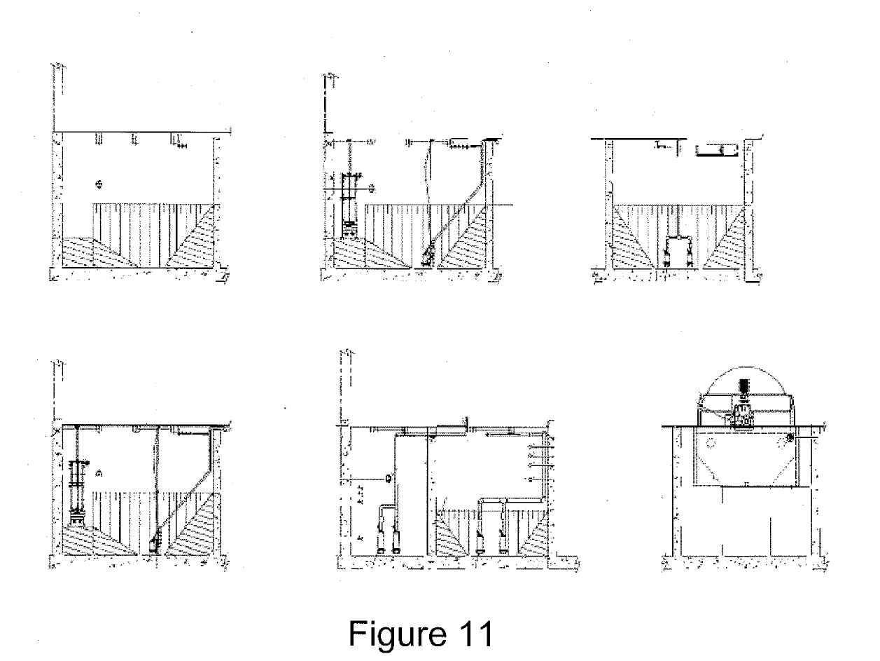

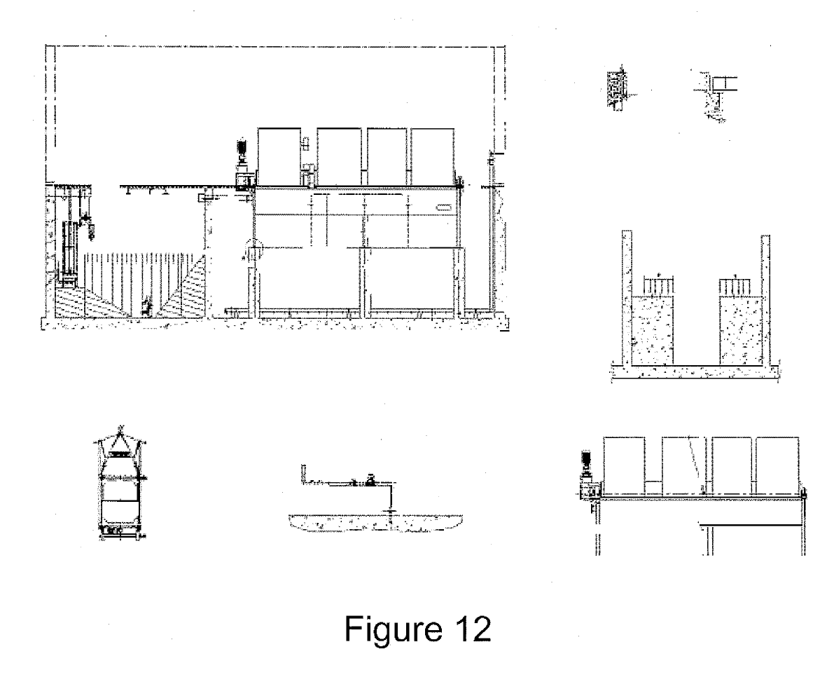

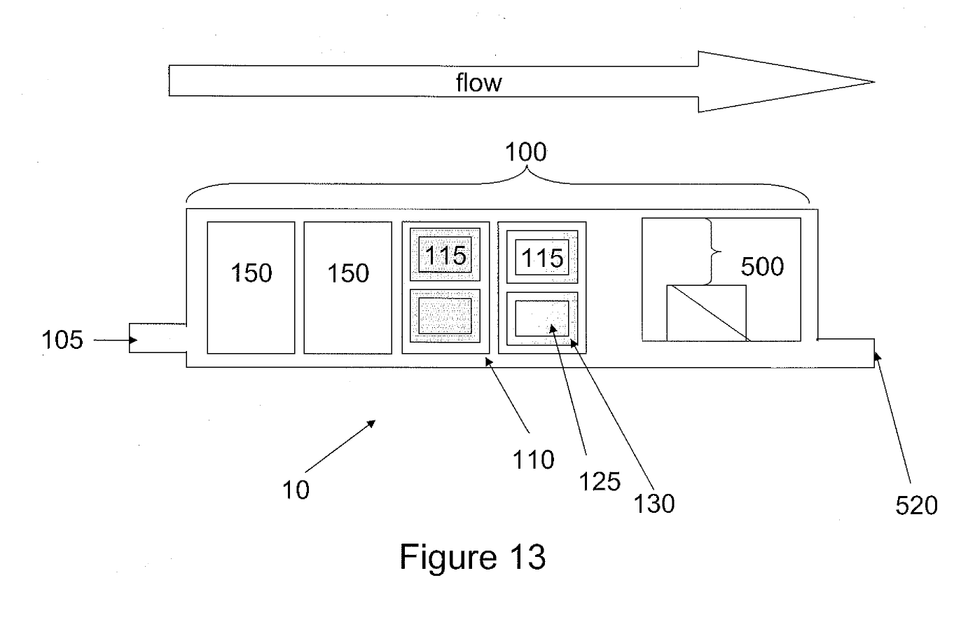

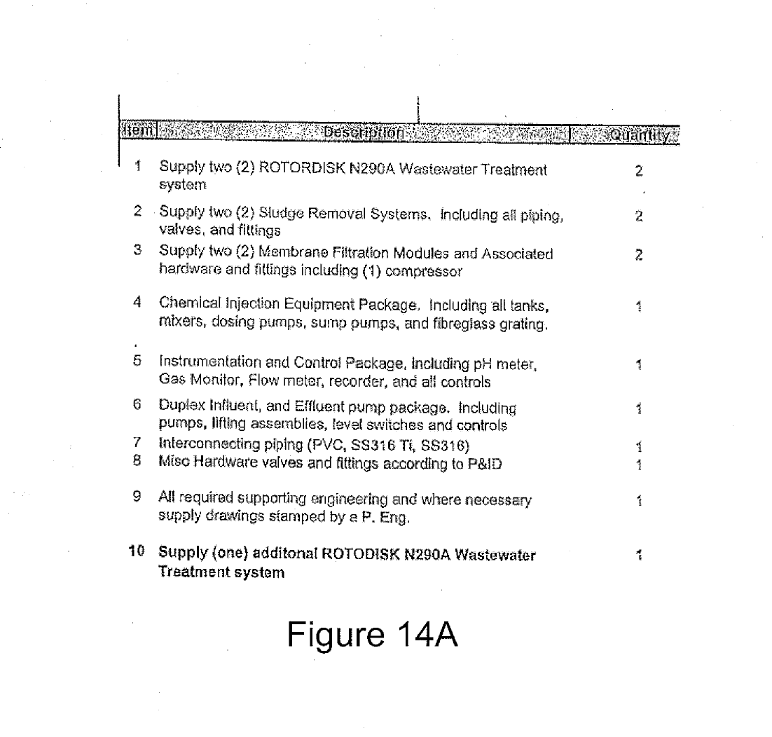

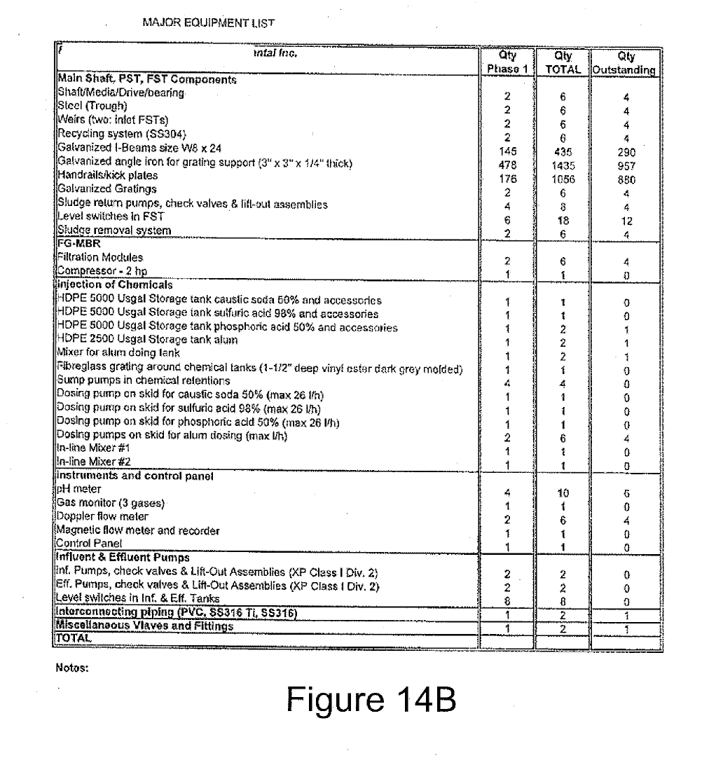

Referring to FIGS. 10-12, in one embodiment, the B-MIT comprises a high efficiency aerobic bioreactor that receives raw water from a primary settling tank and sicharges to a membrane system. In the illustrated embodiment, the B-MIT is designed for an Average Daily Flow rate (ADF) of 1.5MGD at design ADF and is designed to handle to following operation conditions:

| | | | Influent | | |
|---|---|---|---|---|---|
| Parameter | Daily Maximum | | Range | Effluent | |
| Average | 1,500,000 | GPD | No Minimum | ≦1,500,000 | GPD |
| Daily Flow | | | | | |
| (ADF) | | | | | |
| BOD₅ | 1,136 | Kg | Design | ≦2 | mg/L |
| | | | 200 mg/L | | |
| | | | Maximum | | |
| | | | 800 mg/L | | |
| TSS | 1,136 | Kg | Design | ≦2 | mg/L |
| | | | 200 mg/L | | |
| | | | Maximum | | |
| | | | 800 mg/L | | |
| Ammonia | N/A | | N/A | <0.5 | mg/L |
| NH₄⁺ & NH₃ | | | | | |
| Total | 62 | Kg | 10 mg/L | 0.1 | mg/L |
| Phosphorous | | | | | |

It is expected that the operational cost of for this embodiment will be about 50-about 70% lower than that of any other commercially available system including Membrane Bioreactors (MBR's), which is achieved primarily through energy efficiency.

In this embodiment, raw water is either pumped or flows by gravity to a Primary Settling Tank (PST) in which a large percentage of the solids in the raw water settles. Liquid waste flows from the PST to a high efficiency aerobic bioreactor that comprises a four stage Rotating Biological Contactor (RBC) of the Rotordisk® design. Each stage of the RBC provides successively higher stages of treatment. All of the soluble BOD5 and much of the suspended BOD5 is consumed in stages I and II of the RBC. Stages III and IV are for nitrification. Following stage IV of the RBC, approximately 20-25% of the treated water flows into the membrane array with the remainder of treated raw water recycling back into the PST. The membranes are immersed and there is a minimum of 5 cm of head above the membranes. The head pressure causes permeation through the membranes. The membranes have a pore size of 0.08 micron nominal and 0.10 micron absolute. Suspended solids which accumulate in the membrane tank (the retentate side of the membrane system) are returned to the PST. A coarse bubble diffuser scours the surface of the membrane. The diffuser is part of the membrane module assembly.

Referring to FIGS. 10-12, the B-MIT comprises:
a) Holding tank with inputs and outputs;
b) rotating media assembly including drive system, reduction gearbox, bearings, shields and guards and related equipment (4 per phase, total of 12);
c) rotorzone shaft assembly consisting of four (4) multiple sections of biological support media, factory mounted on one shaft to form a complete assembly (4 per phase, total of 12);
d) four (4) section Rotorzone complete with fixed ¼″ steel plate flow control baffles, drive shaft bearing supports, and grating/access supports. The entire Rotorzone is sandblasted and coated with Devtar 5A to a minimum sixteen (16) mm thickness (4 per phase, total of 12);
e) immersed membranes with 280 sq.m of membrane surface area. Flat sheet membranes. Permeation driven by head over membranes;
f) membrane cleaning tank;
g) interior grating and support beams; complete assembly;
h) ultraviolet light (2 per phase, total of 8)
i) electrical package consisting of wiring, PLC controls, SCADA system and torch screen operator interface. There are two user interfaces of which one is intended for on-site and one in a remote location.
j) Handrails and related hardware; complete assembly; and
k) Submersible sludge return pumps and motor.

### Example 2

Raw water is either pumped or flows by gravity to a Primary Settling Tank (PST) in which a large percentage of the solids in the raw water settles. If necessary, the temperature of the raw water is raised to a minimum of 15° C. Liquid waste flows from the PST to the high efficiency aerobic bioreactor described above. The raw water is successively treated in the RBC. Following stage IV of the RBC, if necessary, the pH of the raw water exiting the PST is adjusted to and then maintained at between about 5.5 and about 6.3 for example by using a suitable amount of aluminium-silicate composite coagulant to create filterable flocs of aluminum phosphate which are dispersed in the biologically treated water. The biologically, chemically and physically pre-treated water enters the membrane array or is being recycled back into the PST.

### Example 3

### Test Facility

As a first step towards the integration of a filtration system with the ROTORDISK®, a testing phase is proposed. Based on the results of the testing phase, a standardized process can be developed. It is possible for the testing phase to take place with a full scale ROTORDISK® on site. The purpose of the testing would be to:
(1) Determine the level of BOD and TSS removal with the submerged membrane
(2) Evaluate the TMP and permeate flux
(3) Assess the amount of aeration needed
(4) Potentially compare flat sheet and hollow fiber membrane capabilities
(5) Assess the feasibility of gravitational filtration
(6) Evaluate cleaning requirements
(7) Consider the effect of advanced phosphorous removal on the membrane

The expected influent and effluent concentrations are as shown in Table 2.

TABLE 2
Testing phase - Filtration System with ROTORDISK ®

| | Influent | FST | Effluent Target |
|---|---|---|---|
| BOD (mg/L) | 250 | 30 | 5 |
| TSS (mg/L) | 250 | 30 | 5 |

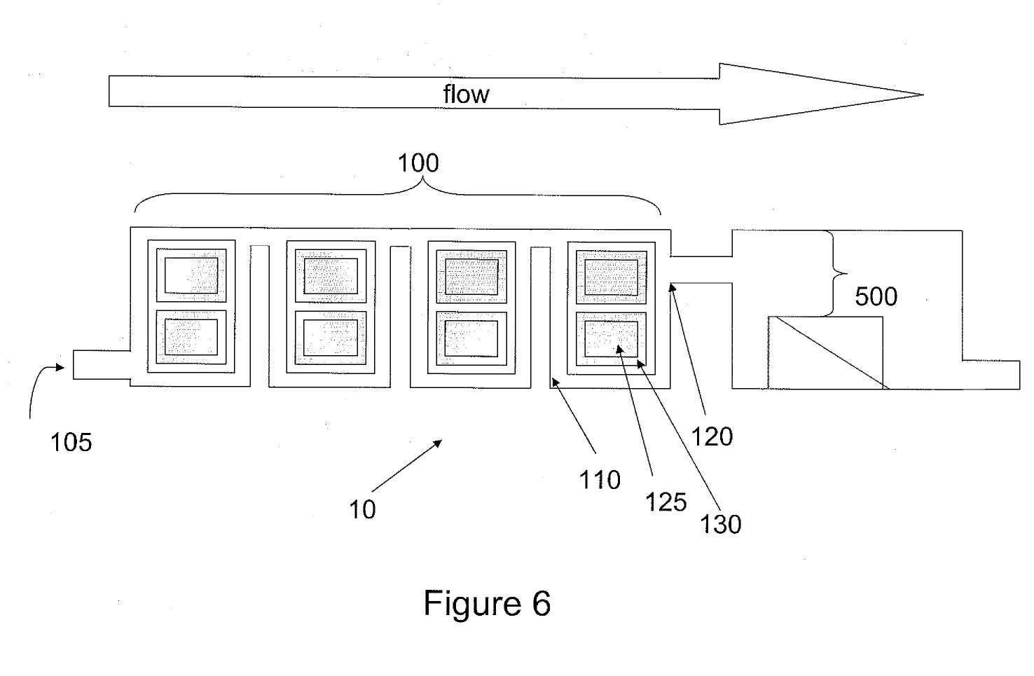

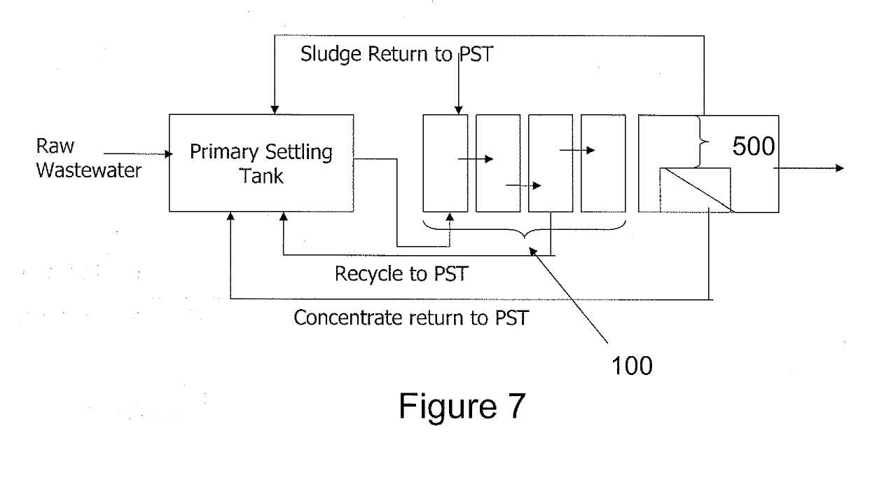

Table 3 compares Kubota and Toray membranes for a small system (˜12 m³/day) to give an initial idea of flux, dimensions, and membrane area requirement. A schematic of the Kubota system is given in FIG. 6 and in FIG. 7, the Kubota system is shown placed in a B100 ROTORDISK®.

TABLE 3
Comparison of Kubota and Toray membranes for the integration
of an MBR with a ROTORDISK ®

| | Kubota | Toray |
|---|---|---|
| | FS50 | TMR140-50S |
| Membrane Configuration | Flat Plate | Flat Plate |
| Pore Size (μm) | 0.4 | 0.08 |
| Membrane Area (m²) | 40 | 70 |
| Clean Water Flux (m³/m²d) | 1.33 | 0.9* lower due |
| | | to pore size |
| Expected Permeate Flux | 0.67-1.2 | 0.8 |
| (m³/m²d) | | |
| Maximum Average Daily | 53 | 63 |
| Flow (m³/day) | | |
| Recommended Aeration | 0.63-1 | 0.65-1 |
| Rate (m³/min) | | |
| Recommended TMP (kPa) | 5-20 | Less than 20 kPa |
| Gravitational Filtration | Considered standard | Less than 20 kPa |
| | by manufacturer | |
| Dimensions (L × W × H, m) | 1.3 × 1.3 × 2 | 0.95 × 0.81 × 2.1 |
| | (includes aerator) | (no aerator) |
| Cleaning | Cleaning with | Cleaning with |
| | chemicals every | chemicals every |
| | 6 months | 6 months |
| | Diffuser cleaning | Diffuser cleaning |
| | with a cleaning | |
| | valve every 2 weeks | |
| Estimated Cost | $14 000 | $7 440 |
| | (membrane module, | (membrane module |
| | membrane case, | with manifold |
| | diffuser and | connections for |
| | diffuser case, | permeate and |
| | lifting tool and | manifolds for air) |
| | connection points) | |

### Example 4

### Test Data from Lafleche Environmental Inc. Leachate Wastewater Treatment Plant

The leachate wastewater treatment facility system comprises three four-stage RBC's of the Rotordisk® design each with an associated membrane filtration system. Prior to entering the RBC, the raw leachate is chemically treated for metals and the pH is measured and adjusted where appropriate. The leachate enters into the Primary Settling Tanks (PST) in the RBC, where alum is injected for phosphorus removal as described above. From the PST, the leachate flows through the RBC where it is progressively treated and into a final settling tank (FST). From the FST the treated leachate enters the membrane system for filtration. The final effluent from the membrane system is sent to the effluent monitoring pond where it is sampled to verify that it meets dry ditch discharge criteria.

Tables 4 to 7 shows typical influent data from a leachate wastewater treatment facility. Tables 8 to 12 shows typical effluent data following treatment of the leachate with one embodiment of the B-MIT.

TABLE 4
Client I.D.: Influent
Sample I.D.: B07-38169-1
Date Collected: 13-Dec-07

| | | | Reference | Date | |
|---|---|---|---|---|---|
| Parameter | Units | M.D.L. | Method | Analyzed | |
| Alkalinity (as | mg/L | 5 | EPA 310.2 | 17-Dec-07 | 2940 |
| CaCO3) | | | | | |
| Ammonia (N)- | mg/L | 0.01 | EPA 350.2 | 17-Dec-07 | 44.7 |
| Total | | | | | |
| o-Phosphate (P) | mg/L | 0.01 | EPA 365.1 | 17-Dec-07 | 3.04 |
| Phosphorus-Total | mg/L | 0.01 | EPA 365.4 | 27-Dec-07 | 4.39 |
| CBOD5 | mg/L | 3 | SM 5210 | 17-Dec-07 | 15 |
| BOD | mg/L | 3 | SM 5210 | 21-Dec-07 | 25 |
| Total Suspended | mg/L | 3 | SM 2540 | 19-Dec-07 | 27 |
| Solids | | | | | |
| Copper | mg/L | 0.002 | SM 3120 | 18-Dec-07 | 0.043 |
| Iron | mg/L | 0.005 | SM 3120 | 18-Dec-07 | 0.260 |
| Zinc | mg/L | 0.005 | SM 3120 | 18-Dec-07 | 0.096 |

TABLE 5
Client I.D.: Influent
Sample I.D.: B08-01195-1
Date Collected: 10-Jan-08

| | | | Reference | Date | |
|---|---|---|---|---|---|
| Parameter | Units | M.D.L. | Method | Analyzed | |
| Alkalinity | mg/L | 5 | EPA 310.2 | 14-Jan-08 | 3130 |
| (as CaCO3) | | | | | |
| Ammonia (N)- | mg/L | 0.01 | EPA 350.2 | 15-Jan-08 | 41.7 |
| Total | | | | | |
| o-Phosphate (P) | mg/L | 0.01 | EPA 365.1 | 15-Jan-08 | 2.83 |
| Phosphorus-Total | mg/L | 0.01 | EPA 365.4 | 14-Jan-08 | 4.13 |
| BOD | mg/L | | SM 5210 | | — |
| Total Suspended | mg/L | 3 | SM 2540 | 14-Jan-08 | 32 |
| Solids | | | | | |
| CBOD5 | mg/L | | SM 5210 | | — |
| Copper | mg/L | 0.002 | SM 3120 | 11-Jan-08 | 0.030 |
| Iron | mg/L | 0.005 | SM 3120 | 11-Jan-08 | 0.200 |
| Zinc | mg/L | 0.005 | SM 3120 | 11-Jan-08 | 0.062 |

TABLE 6
Client I.D.: Influent
Sample I.D.: B08-05279-1
Date Collected: 21-Feb-08

| | | | Reference | Date/Site | |
|---|---|---|---|---|---|
| Parameter | Units | M.D.L. | Method | Analyzed | |
| Alkalinity | mg/L | 5 | EPA 310.2 | 25-Feb-08/O | 3080 |
| (as CaCO3) | | | | | |
| Ammonia (N)- | mg/L | 0.01 | EPA 350.2 | 22-Feb-08/O | 47.9 |
| Total | | | | | |
| Phosphorus- | mg/L | 0.01 | EPA 365.4 | 22-Feb-08/O | 4.26 |
| Total | | | | | |
| BOD | mg/L | 3 | SM 5210 | 22-Feb-08/O | <10 |
| CBOD5 | mg/L | 3 | SM 5210 | 22-Feb-08/O | <10 |
| Total | mg/L | 3 | SM 2540 | 25-Feb-08/O | 16 |
| Suspended | | | | | |
| Solids | | | | | |
| Copper | mg/L | 0.002 | SM 3120 | 22-Feb-08/O | 0.026 |
| Iron | mg/L | 0.005 | SM 3120 | 22-Feb-08/O | 0.146 |
| Zinc | mg/L | 0.005 | SM 3120 | 22-Feb-08/O | 0.057 |
| Sulphate | mg/L | 1 | EPA 300.0 | 22-Feb-08/O | 460 |

TABLE 7
Client I.D.: Influent
Sample I.D.: B08-01195-1
Date Collected: 10-Jan-08

| | | | Reference | Date | |
|---|---|---|---|---|---|
| Parameter | Units | M.D.L. | Method | Analyzed | |
| Alkalinity | mg/L | 5 | EPA 310.2 | 14-Jan-08 | 3130 |
| (as CaCO3) | | | | | |
| Ammonia (N)- | mg/L | 0.01 | EPA 350.2 | 15-Jan-08 | 41.7 |
| Total | | | | | |
| o-Phosphate (P) | mg/L | 0.01 | EPA 365.1 | 15-Jan-08 | 2.83 |
| Phosphorus-Total | mg/L | 0.01 | EPA 365.4 | 14-Jan-08 | 4.13 |
| BOD | mg/L | 3 | SM 5210 | 12-Jan-08 | 30 |
| CBOD5 | mg/L | 3 | SM 5210 | 12-Jan-08 | 22 |
| Total Suspended | mg/L | 3 | SM 2540 | 14-Jan-08 | 32 |
| Solids | | | | | |
| Copper | mg/L | 0.002 | SM 3120 | 11-Jan-08 | 0.030 |
| Iron | mg/L | 0.005 | SM 3120 | 11-Jan-08 | 0.200 |
| Zinc | mg/L | 0.005 | SM 3120 | 11-Jan-08 | 0.062 |

TABLE 8
Client I.D.: West Wetland Pond
Sample I.D.: B08-12572-1
Date Collected: 28-Apr-08

| | | | Reference | Date/Site | |
|---|---|---|---|---|---|
| Parameter | Units | M.D.L. | Method | Analyzed | |
| Ammonia (N)- | mg/L | 0.01 | EPA 350.2 | 03-May- | 0.10 |
| Total | | | | 08/O | |
| Phosphorus- | mg/L | 0.01 | EPA 365.4 | 03-May- | 0.06 |
| Total | | | | 08/O | |
| Total | mg/L | 3 | SM 2540 | 30-Apr-08/O | 3 |
| Suspended | | | | | |
| Solids | | | | | |
| Copper | mg/L | 0.002 | SM 3120 | 29-Apr-08/O | 0.007 |
| Iron | mg/L | 0.005 | SM 3120 | 29-Apr-08/O | 0.141 |
| Zinc | mg/L | 0.005 | SM 3120 | 29-Apr-08/O | 0.076 |
| CBOD5 | mg/L | 3 | SM 5210 | 30-Apr-08/O | <3 |
| Sulphate | mg/L | 1 | EPA 300.0 | 30-Apr-08/O | 1100 |

TABLE 9
Client I.D.: West Holding Pond Composite
Sample I.D.: B08-15023-1
Date Collected: 16-May-08

| | | | Reference | Date/Site | |
|---|---|---|---|---|---|
| Parameter | Units | M.D.L. | Method | Analyzed | |
| Ammonia (N)- | mg/L | 0.01 | EPA 350.2 | 26-May-08/O | 0.09 |
| Total | | | | | |
| o-Phosphate (P) | mg/L | 0.01 | EPA 365.1 | 26-May-08/O | <0.01 |
| Phosphorus- | mg/L | 0.01 | EPA 365.4 | 27-May-08/O | 0.12 |
| Total | | | | | |
| CBOD5 | mg/L | 3 | SM 5210 | 17-May-08/O | 3 |
| Total Suspended | mg/L | 3 | SM 2540 | 29-May-08/O | <3 |
| Solids | | | | | |
| Copper | mg/L | 0.002 | SM 3120 | 20-May-08/O | 0.008 |
| Iron | mg/L | 0.005 | SM 3120 | 20-May-08/O | 0.036 |
| Zinc | mg/L | 0.005 | SM 3120 | 20-May-08/O | 0.037 |

TABLE 10
Client I.D.: West Holding Pond Composite
Sample I.D.: B08-15023-1
Date Collected: 16-May-08

| | | | Reference | Date/Site | |
|---|---|---|---|---|---|
| Parameter | Units | M.D.L. | Method | Analyzed | |
| Ammonia (N)- | mg/L | 0.01 | EPA 350.2 | 26-May-08/O | 0.09 |
| Total | | | | | |
| o-Phosphate (P) | mg/L | 0.01 | EPA 365.1 | 26-May-08/O | <0.01 |
| Phosphorus-Total | mg/L | 0.01 | EPA 365.4 | 27-May-08/O | 0.12 |
| CBOD5 | mg/L | 3 | SM 5210 | 17-May-08/O | 3 |
| Total Suspended | mg/L | 3 | SM 2540 | 29-May-08/O | <3 |
| Solids | | | | | |
| Copper | mg/L | 0.002 | SM 3120 | 20-May-08/O | 0.008 |
| Iron | mg/L | 0.005 | SM 3120 | 20-May-08/O | 0.036 |
| Zinc | mg/L | 0.005 | SM 3120 | 20-May-08/O | 0.037 |

TABLE 11
Client I.D.: East Holding Pond Composite
Sample I.D.: B08-23936-1
Date Collected: 25-Jul-08

| | | | Reference | Date/Site | |
|---|---|---|---|---|---|
| Parameter | Units | M.D.L. | Method | Analyzed | |
| Sodium | mg/L | 0.2 | SM 3120 | 28-Jul-08/O | 882 |
| Zinc | mg/L | 0.005 | SM 3120 | 28-Jul-08/O | 0.019 |
| Benzene | μg/L | 0.5 | EPA 8260 | 28-Jul-08/O | <0.5 |
| Bromo- | μg/L | 0.1 | EPA 8260 | 28-Jul-08/O | 1.5 |
| dichloromethane | | | | | |
| Bromoform | μg/L | 0.1 | EPA 8260 | 28-Jul-08/O | 1.5 |
| Bromomethane | μg/L | 0.3 | EPA 8260 | 28-Jul-08/O | <0.3 |
| Carbon | μg/L | 0.2 | EPA 8260 | 28-Jul-08/O | <0.2 |
| Tetrachloride | | | | | |
| Monochlorobenzene | μg/L | 0.2 | EPA 8260 | 28-Jul-08/O | <0.2 |
| (Chlorobenzene) | | | | | |
| Chloroform | μg/L | 0.3 | EPA 8260 | 28-Jul-08/O | 7.1 |
| Dibromo- | μg/L | 0.1 | EPA 8260 | 28-Jul-08/O | 2.2 |
| chloromethane | | | | | |
| Dibromoethane,1,2- | μg/L | 0.1 | EPA 8260 | 28-Jul-08/O | <0.1 |
| (Ethylene | | | | | |
| Dibromide) | | | | | |
| Dichloro- | μg/L | 0.1 | EPA 8260 | 28-Jul-08/O | <0.1 |
| benzene,1,2- | | | | | |
| Dichloro- | μg/L | 0.1 | EPA 8260 | 28-Jul-08/O | <0.1 |
| benzene,1,3- | | | | | |
| Dichloro- | μg/L | 0.2 | EPA 8260 | 28-Jul-08/O | <0.2 |
| benzene,1,4- | | | | | |
| Dichloro- | μg/L | 0.1 | EPA 8260 | 28-Jul-08/O | <0.1 |
| ethane,1,1- | | | | | |
| Dichloroethane,1,2- | μg/L | 0.1 | EPA 8260 | 28-Jul-08/O | <0.1 |
| Dichloroethene, 1,1- | μg/L | 0.1 | EPA 8260 | 28-Jul-08/O | <0.1 |
| Dichloroethene, cis- | μg/L | 0.1 | EPA 8260 | 28-Jul-08/O | <0.1 |
| 1,2- | | | | | |
| Dichloroethene, | μg/L | 0.1 | EPA 8260 | 28-Jul-08/O | <0.1 |
| trans-1,2- | | | | | |
| Dichloro- | μg/L | 0.1 | EPA 8260 | 28-Jul-08/O | <0.1 |
| propane,1,2- | | | | | |
| Dichloropropene, | μg/L | 0.1 | EPA 8260 | 28-Jul-08/O | <0.1 |
| cis-1,3- | | | | | |
| Dichloropropene, | μg/L | 0.1 | EPA 8260 | 28-Jul-08/O | <0.1 |
| trans-1,3- | | | | | |
| Ethylbenzene | μg/L | 0.5 | EPA 8260 | 28-Jul-08/O | <0.5 |
| Dichloromethane | μg/L | 0.3 | EPA 8260 | 28-Jul-08/O | <0.3 |
| (Methylene | | | | | |
| Chloride) | | | | | |

TABLE 12
Client I.D.: West Holding Pond Composite
Sample I.D.: B08-20144-1
Date Collected: 27-Jun-08

| | | | Reference | Date/Site | |
|---|---|---|---|---|---|
| Parameter | Units | M.D.L. | Method | Analyzed | |
| Ethylbenzene | μg/L | 0.5 | EPA 8260 | 02-Jul-08/O | <0.5 |
| Dichloromethane | μg/L | 0.3 | EPA 8260 | 02-Jul-08/O | <0.3 |
| (Methylene Chloride) | | | | | |
| Naphthalene | μg/L | 0.7 | EPA 8260 | 02-Jul-08/O | <0.7 |
| Styrene | μg/L | 0.6 | EPA 8260 | 02-Jul-08/O | <0.6 |
| Tetrachloro- | μg/L | 0.1 | EPA 8260 | 02-Jul-08/O | <0.1 |
| ethane,1,1,1,2- | | | | | |
| Tetrachloro- | μg/L | 0.4 | EPA 8260 | 02-Jul-08/O | <0.4 |
| ethane,1,1,2,2- | | | | | |
| Tetrachloroethylene | μg/L | 0.2 | EPA 8260 | 02-Jul-08/O | <0.2 |
| Toluene | μg/L | 0.5 | EPA 8260 | 02-Jul-08/O | <0.5 |
| Trichloro- | μg/L | 0.2 | EPA 8260 | 02-Jul-08/O | <0.2 |
| benzene,1,2,4- | | | | | |
| Trichloroethane,1,1,1- | μg/L | 0.1 | EPA 8260 | 02-Jul-08/O | <0.1 |
| Trichloroethane,1,1,2- | μg/L | 0.1 | EPA 8260 | 02-Jul-08/O | <0.1 |
| Trichloroethylene | μg/L | 0.1 | EPA 8260 | 02-Jul-08/O | <0.1 |
| Vinyl Chloride | μg/L | 0.2 | EPA 8260 | 02-Jul-08/O | <0.2 |
| Xylene, m,p- | μg/L | 1.0 | EPA 8260 | 02-Jul-08/O | <1.0 |
| Xylene, o- | μg/L | 0.5 | EPA 8260 | 02-Jul-08/O | <0.5 |
| Dichloroethane-d4,1,2- | % | 10 | EPA 8260 | 02-Jul-08/O | 104 |
| (SS) | | | | | |
| Toluene-d8 (SS) | % | 10 | EPA 8260 | 02-Jul-08/O | 96 |
| Bromofluoro- | % | 10 | EPA 8260 | 02-Jul-08/O | 109 |
| benzene,4(SS) | | | | | |

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1. An integrated water processing technology comprising:
one or more immobilized cellular systems in fluid communication with a membrane system comprising one or more membrane units;
each of the one or more immobilized cellular systems comprising a holding tank having a raw water input and effluent output and one or more biological treatment/processing units;
each of the one or more biological treatment/processing units comprising a biological component and a biological support component;
wherein the membrane system receives water from said one or more immobilized cells systems and filters said water to remove contaminants.

2. The integrated water processing technology of claim 1; wherein the one or more immobilized cellular systems are in parallel or in series.

3. The integrated water processing technology of claim 1 comprising one immobilized cellular system.

4. The integrated water processing technology of claim 1, wherein the immobilized cellular system comprises one or more fixed-growth biological treatment/processing units selected from the group consisting of fixed-cell, fixed-film, fixed bed, fluidized beds, air-sparged, trickling filters and rotating media reactors.

5. The integrated water processing technology of claim 4 wherein said rotating media reactor is a rotating biological contactor or packed cage rotating biological contactor.

6. The integrated water processing technology of claim 4 wherein said rotating media reactor is a Rotordisk®.

7. The integrated water processing technology of claim 1 further comprising a post-denitrification removal system.

8. The integrated water processing technology of claim 1 further comprising a phosphorous removal system.

9. The integrated water processing technology of claim 1 further comprising a system for enhancing microbial growth.

10. The integrate water processing technology of claim 1 further comprising a means for adding an effective amount of at least one water soluble cationic polymer to the raw water or biologically processed water.

11. The integrate water processing technology of claim 1 further comprising a means for adding an effective amount of at least one water soluble anionic polymer to the raw water or biologically processed water.

12. The integrate water processing technology of claim 1 further comprising a means for metals removal.

13. The integrate water processing technology of claim 1 further comprising a means for toxicity removal.

14. The integrate water processing technology of claim 1 further comprising a means for “effluent organic matter” removal.

15. The integrate water processing technology of claim 1 further comprising a means for “emerging contaminants” removal.
